(19) United States
(12) Patent Application Publication
(10) Pub. No.: US 2024/0198239 A1
(43) Pub. Date: Jun. 20, 2024

(54) GAME SYSTEM AND NON-TRANSITORY COMPUTER-READABLE MEDIUM INCLUDING VIDEO GAME PROCESSING PROGRAM

(71) Applicant: Square Enix Co. Ltd., Tokyo (JP)

(72) Inventors: Naoyuki TAMATE, Tokyo (JP); Yosuke TOYODA, Tokyo (JP)

(21) Appl. No.: 18/541,905

(22) Filed: Dec. 15, 2023

(30) Foreign Application Priority Data
Dec. 15, 2022 (JP) 2022-199879
Aug. 1, 2023 (JP) 2023-125431

(51) Int. Cl. A63F 13/85; G06Q 20/36

(52) U.S. Cl. CPC A63F 13/85; G06Q 20/3678

(57) ABSTRACT

A game system includes a game terminal device that executes a video game including one or more contents used in the game, and a server device that is connected to the game terminal device via a communication network and controls progress of the video game. The game system includes an issuer for issuing a non-fungible token (NFT) corresponding to the content in a blockchain network, with a user who is an acquirer of the content as an owner, an acquirer for acquiring transaction information of secondary distribution for each NFT corresponding to the content in the blockchain network, and a granter for granting an in-game privilege to a user of the video game in a case where a granting condition related to the transaction information is satisfied.

### CROSS-REFERENCE TO RELATED APPLICATION(S)

The present disclosure claims priority to Japanese Patent Application No. 2022-199879, filed on Dec. 15, 2022 and Japanese Patent Application No. 2023-125431, filed on Aug. 1, 2023, the disclosures of which are expressly incorporated herein by reference in their entirety for any purpose.

### TECHNICAL FIELD

At least one embodiment of the present disclosure relates to a game system and a non-transitory computer-readable medium including a video game processing program.

### BACKGROUND

In recent years, NFT games (blockchain games) using the blockchain technology have started to be provided. Examples of the NFT games can be found at “CRYPTO SPELLS”, [online], CryptoGames Co., Ltd., [as of Nov. 29, 2022], Internet <URL: https://cryptospells.jp/). In an NFT game, for example, contents such as characters and items used in the game serve as NFTs (non-fungible tokens). Thus, NFTs such as characters can be traded on marketplaces and the like.

### SUMMARY

The above-described NFT game is characterized by “Play to Earn (P2E)”, and an object is to improve the interest of the game by more associating NFT transactions for characters with the game play.

An object of at least one embodiment of the present disclosure is to solve deficiencies of the related technology.

From a non-limiting viewpoint, a game system according to an embodiment of the present disclosure includes a game terminal device that executes a video game including one or more contents used in a game, and a server device that is connected to the game terminal device via a communication network and controls progress of the video game. The game system includes an issuer for issuing a non-fungible token (referred to as an NFT below) corresponding to the content in a blockchain network, with a user who is an acquirer of the content as an owner, an acquirer for acquiring transaction information of secondary distribution for each NFT corresponding to the content in the blockchain network, and a granter for granting an in-game privilege to a user of the video game in a case where a granting condition related to the transaction information is satisfied.

From a non-limiting viewpoint, a non-transitory computer-readable medium according to the embodiment of the present disclosure includes a video game processing program causing a computer that controls progress of a video game including one or more contents used in a game, to execute: an issuing function of issuing a non-fungible token (referred to as an NFT below) corresponding to the content in a blockchain network, with a user who is an acquirer of the content as an owner, an acquisition function of acquiring transaction information of secondary distribution for each NFT corresponding to the content in the blockchain network, and a granting function of granting an in-game privilege to a user of the video game in a case where a granting condition related to the transaction information is satisfied.

From a non-limiting viewpoint, a non-transitory computer-readable medium according to the embodiment of the present disclosure includes a video game processing program causing a server device that is connected to a game terminal device via a communication network and controls progress of a video game, the game terminal device executing the video game including one or more contents used in the game, to execute: an issuing function of issuing a non-fungible token (referred to as an NFT below) corresponding to the content in a blockchain network, with a user who is an acquirer of the content as an owner, an acquisition function of acquiring transaction information of secondary distribution for each NFT corresponding to the content in the blockchain network, and a granting function of granting an in-game privilege to a user of the video game in a case where a granting condition related to the transaction information is satisfied.

Each embodiment of the present application solves one or two or more deficiencies.

### BRIEF DESCRIPTION OF THE DRAWINGS

FIG. 1 is a block diagram illustrating an example of a configuration of a game system according to at least one embodiment of the present disclosure.

FIG. 2 is a block diagram illustrating a configuration of a server device according to at least one embodiment of the present disclosure.

FIG. 3 is a flowchart illustrating an example of a granting process according to at least one embodiment of the present disclosure.

FIG. 4 is a flowchart illustrating an example of a login process according to at least one embodiment of the present disclosure.

FIG. 5 is a block diagram illustrating a configuration of a server device according to at least one embodiment of the present disclosure.

FIG. 6 is a flowchart illustrating an example of a granting process according to at least one embodiment of the present disclosure.

FIG. 7 is a flowchart illustrating an example of a login process according to at least one embodiment of the present disclosure.

FIGS. 8A and 8B are schematic diagrams illustrating an example of an NFT character according to at least one embodiment of the present disclosure.

FIG. 9 is a block diagram illustrating a configuration of a server device according to at least one embodiment of the present disclosure.

FIG. 10 is a diagram illustrating an example of user data according to at least one embodiment of the present disclosure.

FIG. 11 is a flowchart illustrating an example of a granting process according to at least one embodiment of the present disclosure.

FIG. 12 is a flowchart illustrating an example of a login process according to at least one embodiment of the present disclosure.

FIG. 13 is a block diagram illustrating a configuration of a server device according to at least one embodiment of the present disclosure.

FIG. 14 is a flowchart illustrating an example of a granting process according to at least one embodiment of the present disclosure.

FIG. 15 is a flowchart illustrating an example of a login process according to at least one embodiment of the present disclosure.

FIG. 16 is a block diagram illustrating an example of a configuration of a game system according to at least one embodiment of the present disclosure.

FIG. 17 is a block diagram illustrating a configuration of a server device according to at least one embodiment of the present disclosure.

FIG. 18 is a diagram illustrating one example of user data according to at least one embodiment of the present disclosure.

FIG. 19 is a flowchart illustrating an example of a granting process according to at least one embodiment of the present disclosure.

FIG. 20 is a flowchart illustrating an example of a login process according to at least one embodiment of the present disclosure.

### DETAILED DESCRIPTION

Hereinafter, examples of embodiments of the present disclosure will be described with reference to the drawings. Various constituents in the example of each embodiment described below can be appropriately combined without contradiction or the like. In addition, contents described as an example of a certain embodiment may not be described in other embodiments. In addition, contents of operations or processes not related to a characteristic part of each embodiment may be omitted. Furthermore, the order of various processes constituting various flows described below may be a random order without causing contradiction in processing contents.

### First Embodiment

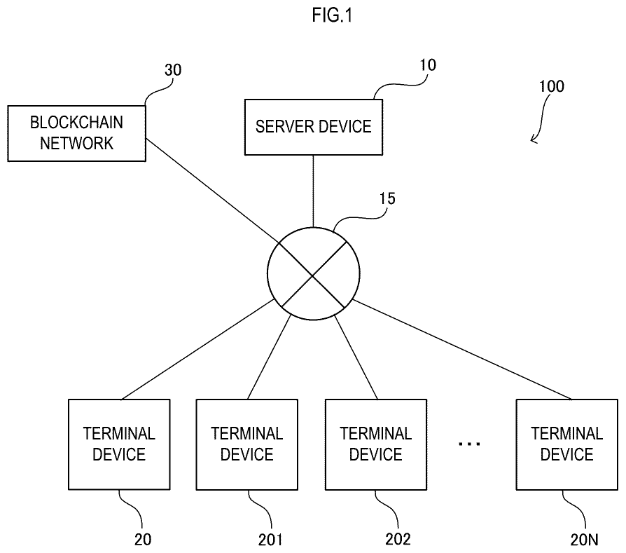

FIG. 1 is a block diagram illustrating an example of a configuration of a game system 100 in an embodiment of the present disclosure. As illustrated in FIG. 1, a game system (system) 100 includes a server device 10 and terminal devices (game terminal devices) 20 and 201 to 20N (N is any integer) used by a plurality of users (players) who play a video game (game). The server device 10 and the plurality of terminal devices 20 and 201 to 20N are each connected to a communication network 15 such as the Internet. The configuration of the system 100 is not limited to this, and may be configured to include a plurality of server devices, for example. Alternatively, a virtual server device may be configured by using cloud computing.

The system 100 also includes a blockchain network 30. The blockchain network 30 is a distributed database network configured by multiple nodes (computers). In the blockchain network 30, data units called blocks are generated and joined like a chain to store a blockchain (distributed ledger). In the blockchain network 30, transactions of fungible tokens, non-fungible tokens (NFTs), and the like are possible. Examples of the blockchain network 30 include an existing platform such as Ethereum. The blockchain network 30 is also an NFT marketplace in which generation (issuance) and trading of NFTs are possible. Since the blockchain technology, including issuance, trading, and the like of an NFT, has a general configuration, the detailed description will be omitted.

The system 100 has various functions of executing a game including one or more contents used in the game. In the game of the example of the present embodiment, an NFT corresponding to the content is issued with a user who is an acquirer of the content as the owner. An in-game privilege is granted to a user of the game in accordance with transaction information (transaction status) of the secondary distribution of the NFT corresponding to the content.

Contents are digital contents, and are creations such as characters and items used in games. For example, a character that helps the progress of the user in the game, a character that is an enemy object of the user, an item that produces a specific effect when used, and the like correspond to the content. For example, the user may acquire a content by purchasing the content (primary distribution) by consuming the legal currency, the virtual currency, or the like.

The transaction information of the secondary distribution corresponds to, for example, the transaction history recorded in a blockchain of the NFT corresponding to the content. The transaction history is updated in the blockchain network 30 each time a transaction of the NFT is executed. The in-game privilege is a benefit granted to the user in order to advance the game advantageously. For example, the in-game privilege includes items that can be used in the game, the right to play special missions (game stages), and the like.

The primary distribution means that an NFT corresponding to a content is handed over to the user (in a new state) without going through other users. The secondary distribution means that an NFT that has been put on the market once (handed over to another party) is sold to the other party again.

The server device 10 is managed by an administrator of the system 100, and has various functions of providing information regarding the progress of the game to the terminal devices 20 and 201 to 20N. The server device 10 provides, for example, game image information and the like regarding acquisition of a content and granting of in-game privileges. The server device 10 is configured by an information processing device such as a WWW server that provides information regarding control of the progress of the game, and includes one or more storage media (storage devices) that store various types of information. The server device 10 also includes a controller and the like configured by a central processing unit (CPU) and the like. Since the above-described configuration is a general configuration, detailed description will be omitted.

The storage device may be configured to be built in the server device 10 or may have a configuration of a storage device such as a database device separate from the server device 10. Alternatively, the blockchain network may be configured as the storage device, as the blockchain.

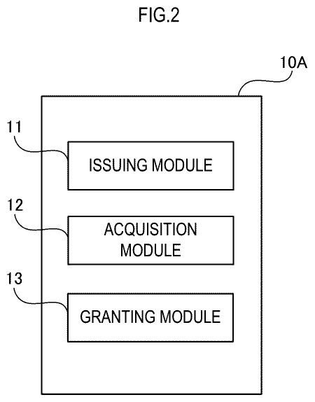

FIG. 2 is a functional block diagram illustrating the configuration of a server device 10A, which is an example of the configuration of the server device 10. The server device 10A includes the controller executing software (a video game processing program) for controlling the progress of the game, including at least an issuing module 11, an acquisition module 12, and a granting module 13, which has been stored in the storage device. The video game processing program also includes game data.

The issuing module (issuing function, issuer) 11 issues an NFT corresponding to a content with the user who is an acquirer of the content as the owner. Issuing an NFT is to record the ownership of the content on the blockchain. That is, a token ID (NFT_ID) is issued for the content, and a blockchain is generated in which metadata, transaction history, etc. are associated with the token ID. The metadata includes information specifying that this is a game content and information specifying the owner, and the like.

For example, the issuing module 11 makes an issuing request to cause the blockchain network 30 to issue an NFT corresponding to the content. For example, the issuing module 11 receives content purchase requests from users (terminal devices 20 and 201 to 20N). As a result, the issuing module 11 executes a payment process (billing process) in the legal currency, the virtual currency, or the like possessed by the user. After completion of the billing process, the issuing module 11 transmits an issuing request for an NFT corresponding to the purchased content to the blockchain network 30. The billing process has a general configuration, and thus detailed description thereof will be omitted.

For example, the issuing module 11 transmits (uploads) information specifying that this is a game content, information specifying the owner, and the like to the blockchain network 30 together with an issuing request for an NFT. As a result, an NFT corresponding to the content is issued in the blockchain network 30. Then, the issuing module 11 transmits the NFT corresponding to the content to a wallet (terminal device) of the purchaser (user).

The information specifying that this is the game content includes, for example, identification information specifying the game and identification information specifying the content. The information specifying the owner is identification information (user ID) of the user who has purchased (acquired) the content. The user ID may be set to, for example, a wallet address of the user (terminal device). The user ID may be stored in the storage device of the server device 10 in association with game identification information (game user ID) of the user, for example.

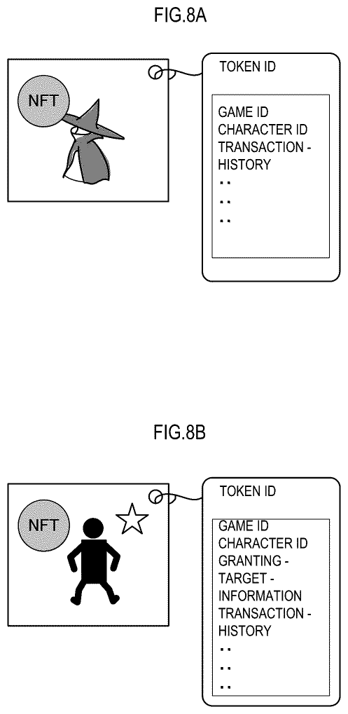

Metadata and a transaction history are also recorded in the blockchain of the NFT corresponding to the content (see FIGS. 8A and 8B, for example). The metadata includes, for example, information specifying that this is the game content described above and information specifying the owner. The transaction history is a history of the secondary distribution of the ownership of the content, and includes pieces of identification information (user IDs) of the transferor and the transferee of the content, and the like.

The information regarding the content to be sold may be stored in the storage device of the server device 10. In a case where a plurality of contents are sold, a list of the contents to be sold may be transmitted to the terminal device 20 to allow the user to select the content to be purchased.

The acquisition module (acquisition function, acquirer) 12 acquires the transaction information of the secondary distribution for each NFT corresponding to a content in the blockchain network 30. The transaction information is, for example, the transaction history described above. For example, the acquisition module 12 may request the blockchain network 30 to transmit the transaction history of the content (NFT) having identification information specifying the game.

The granting module (granting function, granter) 13 grants an in-game privilege to a user of the game in a case where a granting condition related to the transaction information of the secondary distribution is satisfied. The granting condition includes, for example, a condition that the number of transactions (the number of concluded contracts) has reached a predetermined number (for example, 10000 times) or more. That is, in a case where the total number of transfers (the number of transactions) of NFTs corresponding to all contents has reached a predetermined number or more, the granting condition is set to be satisfied. The granting module 13 may determine whether the granting condition is satisfied from the transaction history of NFTs corresponding to all the contents. For example, if the total number of NFT transactions corresponding to all 10 specific characters is 15000, it is determined that the granting condition is satisfied. It is sufficient that the transaction (transfer) of the secondary distribution is configured by changing the owner, or is either a paid transfer or a free transfer.

A target to which the in-game privilege is granted is, for example, all users of the game. Specifically, the target is all the users having a game user IDs that are registered in the server device 10 (storage device). In this case, the granting module 13 may perform granting, for example, at a timing when each user has logged in. In a case where the user logs in, privilege information may be added to the owned items included in user data of this user. Login means permission for the user to access the server device 10. The user data is data regarding the game of the user.

Next, the terminal devices 20 and 201 to 20N will be described. Each of the plurality of terminal devices 20 and 201 to 20N is managed by the user who plays the game, and is configured by a communicable terminal device such as a stationary game device, a personal computer, a mobile phone terminal, a personal digital assistant (PDA), and a portable game device.

Each of the terminal devices 20 and 201 to 20N includes an operation device (operation interface), a storage medium (storage device), a controller configured by a CPU and the like, a display, an audio output device (speaker and the like), a communication controller, and the like. Since the above-described configuration is a general configuration, detailed description will be omitted. Software (an application program) and the like for executing the game by communicating with the server device 10 are stored in the storage device of the terminal devices 20 and 201 to 20N.

The terminal devices 20 and 201 to 20N generate game images based on image information received from the server device 10, for example.

Also, the terminal devices 20 and 201 to 20N may function as wallets, for example. The wallet is a tool for managing tokens. An application program for executing the wallet may be stored in the storage device of each of the terminal devices 20 and 201 to 20N. The NFT corresponding to the content is stored in the wallet of the user who has acquired the content. In this case, wallet information (for example, a wallet address, and the like) may be associated with the game user ID and stored as user data in the server device 10 (storage device), for example.

In addition, the terminal devices 20 and 201 to 20N can also trade NFTs stored in wallets on the blockchain network 30.

Next, an operation of the system 100 will be described.

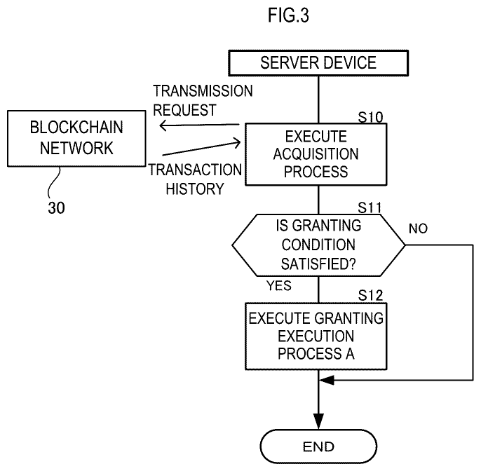

FIG. 3 is a flowchart illustrating an example of a granting process executed by the system 100. The granting process in the example of the present embodiment is a process for granting an in-game privilege. FIG. 3 mainly illustrates a process for acquiring transaction information and a process for granting an in-game privilege to the user, and other processes may be partially omitted.

The granting process in the example of the present embodiment is repeatedly executed, for example, every time a predetermined period of time has elapsed (for example, 24 hours have elapsed).

The server device 10A executes an acquisition process of a transaction history (Step S10). In the acquisition process, for example, the server device 10A transmits a transmission request of a transaction history to the blockchain network 30 together with identification information specifying the game. As a result, the transaction histories of NFTs corresponding to all the contents are transmitted from the blockchain network 30 to the server device 10A.

Then, the server device 10A determines whether or not the granting condition is satisfied (Step S11). The server device 10A may determine whether or not the granting condition is satisfied with reference to all acquired transaction histories. In a case where the granting condition is not satisfied (Step S11: NO), the server device 10A ends the granting process.

On the other hand, in a case where the granting condition is satisfied (Step S11: YES), the server device 10A executes a granting execution process A (Step S12). In the granting execution process A, a process for granting an in-game privilege to the user is executed. In the granting execution process A, the server device 10A performs settings such that, for example, the in-game privilege is granted when each user logs in. Specifically, information in which all users are set as privilege granting target persons at the time of login may be set. Thereafter, the server device 10A ends the granting process.

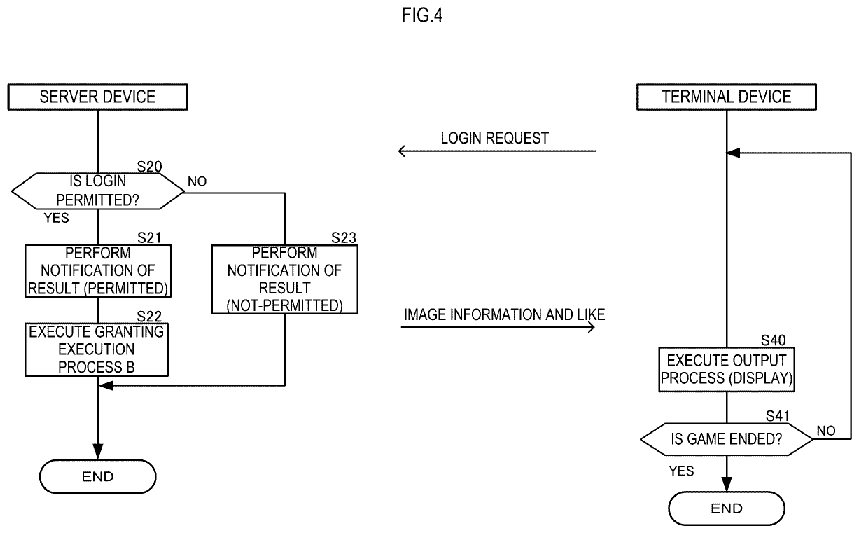

FIG. 4 is a flowchart illustrating an example of a login process executed by the system 100. The login process in the example of the present embodiment is a process for authenticating the user. FIG. 4 mainly illustrates a process for granting the in-game privilege to the user who has logged in, and other processes may be partially omitted. A case where the server device 10A and the terminal device 20 of a user P execute the login process will be described below as an example.

Execution of the login process in the example of the present embodiment is started, for example, in a case where the terminal device 20 issues a login request. The terminal device 20 transmits a login request to the server device 10A together with authentication information such as the game user ID and the authentication password of the user P, for example.

The server device 10A determines whether or not to permit the login (Step S20). For example, the server device 10A may perform authentication by comparing the received authentication information with the game user ID or the like included in the user data stored in the storage device. In a case where the login is not permitted (Step S20: NO), the server device 10A may, for example, transmit, to the terminal device 20, image information for a notification of the result that the login is not permitted (Step S23). Thereafter, the server device 10A ends the login process.

On the other hand, in a case where the login is permitted (Step S20: YES), the server device 10A may, for example, transmit, to the terminal device 20, image information for a notification of the result that the login is permitted (Step S21). Then, the server device 10A executes a granting execution process B (Step S22). In the granting execution process B, the server device 10A adds privilege information (for example, item identification information) to the owned item in the user data (storage device) associated with the user P (game user ID). In the granting execution process B, in a case where the in-game privilege is granted, for example, image information for a notification indicating that the in-game privilege has been granted is transmitted from the server device 10A to the terminal device 20. Thereafter, the server device 10A ends the login process.

On the other hand, the terminal device 20 displays the game image based on the image information and the like received from the server device 10A on the display until the execution of the game is ended (Step S41: YES) (Step S40). In a case where the in-game privilege has been granted, the terminal device 20 displays a game image for a notification indicating that the in-game privilege has been granted.

Although the login process illustrated in FIG. 4 has been described with respect to the terminal device 20, the similar process may be executed for other users (terminal devices).

As described above, as one aspect of the first embodiment, the server device 10A is configured to include the issuing module 11, the acquisition module 12, and the granting module 13. Thus, the in-game privilege is granted in accordance with the transaction status of the NFT corresponding to the content in the game. Therefore, the NFT transaction and the game play are configured to be more associated with each other, and thus it is possible to improve the interest of the game.

Games of various genres can be adopted as the video game in the example in the above-described embodiment as long as the contents such as the characters are used in the game.

Regarding the content in the example in the above-described embodiment, a plurality of the same contents may be provided, or contents of different types may be provided.

As described above, the issuing module in the example in the above-described embodiment may be configured to issue an NFT request to the blockchain network to issue an NFT, or may be configured to issue an NFT itself. Further, the NFT issuance by the issuing module also includes a configuration in which an issued NFT corresponding to the content, the owner of the NFT being an operator of the game, is transferred to the user.

In the example in the embodiment described above, a configuration in which an NFT is issued when a content in the game is purchased by the user has been described, but the subject of NFT issuance is not particularly limited to this. The content may be acquired by the user, and may be, for example, acquired (given) to the user as a result of playing the game.

In the example in the embodiment described above, the number of transactions in the transaction history has been described as the transaction information, but the transaction information is not particularly limited to this as long as the transaction information is information associated with a transaction of the secondary distribution. For example, the transaction information may be a transaction price. The transaction price is included in the transaction history of the NFT. In this case, for example, a granting condition in which the total transaction price has reached a predetermined amount or more may be set. Further, for example, a granting condition in which there is a transaction concluded at a predetermined transaction price or more may be set.

In the example in the embodiment described above, only one granting condition is provided, but a plurality of conditions may be provided. For example, conditions A, B, and C may be provided as the granting conditions. In this case, in a case where any one of the conditions A, B, and C is satisfied, the in-game privilege may be granted on the assumption that the granting condition has been satisfied. Alternatively, in a case where all the conditions A, B, and C are satisfied, the in-game privilege may be granted on the assumption that the granting condition has been satisfied. Also, the granting condition may be changed periodically.

In the example in the embodiment described above, the in-game privilege may be a token that can be used only in the game, but may be an NFT. In this case, the server device (issuing module) may issue an NFT corresponding to the in-game privilege with the user to whom the in-game privilege is to be granted as the owner.

In the example in the embodiment described above, the granting target of the in-game privilege is all users in the game, but the present embodiment is not particularly limited to this. For example, the granting target of the in-game privilege may be only some users in the game. For example, the in-game privilege may be granted only to users who have logged into the game within a predetermined period after the granting condition is satisfied.

The in-game privilege of the example in the above-described embodiment is not limited to the privilege described above. For example, a privilege associated with the above game in other systems may be set as the in-game privilege. Another system is a system capable of providing a predetermined service related to the game to each user. For example, a role on the server related to the game on Discord corresponds to the in-game privilege. In this case, Discord is the other system. On Discord, the server means a community on a network, which is established by voice channels and the like. For example, on Discord, the server related to the game is a community for the game created by the operator of the game. The role means a post (role) in the server, and an authority in the server is set for each type of role. For example, on server related to the game on Discord, a role in which an authority to create a public thread or the like is set is granted to the user as an in-game privilege.

In the case of the above example, the game system (the server device), for example, may communicably cooperate with another system via a communication network, and transmit the roll (in-game privilege) setting request (granting request) to the other system when the user has logged in.

As described above, granting a privilege associated with the game in another system as the in-game privilege contributes to increasing the motivation of the user who plays the game.

In the example in the embodiment described above, the transaction information (transaction history) of the NFT corresponding to the content is used for the entire period from the past to the present, but the present embodiment is not particularly limited to this. The granting condition may be determined by using transaction information for a specific period (for example, a period from the present to one year ago).

In the example in the embodiment described above, all pieces of transaction information of the NFT corresponding to the content used in the game are acquired, but the present embodiment is not particularly limited to this. For example, some pieces of transaction information of the NFTs may be acquired. In this case, information (granting target information) for specifying a target of the transaction information may be registered in the metadata of a target NFT. Then, the blockchain network may be requested to transmit the transaction information of the NFT including the granting target information.

In the example in the embodiment described above, the operating entity of the server device and the operating entity of the blockchain network may be different or the same.

### Second Embodiment

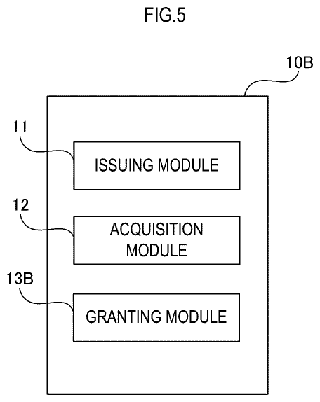

FIG. 5 is a block diagram illustrating a configuration of a server device 10B that is an example of the server device 10. In the example of the present embodiment, the server device 10B includes at least an issuing module 11, an acquisition module 12, and a granting module 13B.

In the example of the present embodiment, whether the granting condition is satisfied is determined for each NFT corresponding to the content. Determination for the granting condition is performed with reference to the transaction information of the NFT corresponding to the content to be determined. For example, it is determined whether the granting condition is satisfied by referring only to transaction information of an NFT corresponding to a character C1, and it is determined whether or not the granting condition is satisfied by referring only to transaction information of an NFT corresponding to a character C2. Also, for example, even in a case where there are a plurality of NFTs corresponding to the same character, it is determined whether the granting condition is satisfied for each NFT corresponding to the character.

The in-game privilege is granted to the user who is the current owner and/or the user who was the past owner for the NFT corresponding to the content for which the granting condition is satisfied. A configuration in which the in-game privilege is granted to the user who is the current owner, and the user who was the past owner for the NFT corresponding to the content for which the granting condition is satisfied will be described below as an example.

The issuing module 11 issues an NFT corresponding to a content with the user who is an acquirer of the content as the owner. For example, the issuing module 11 makes an issuing request to cause the blockchain network 30 to issue an NFT corresponding to the content. For example, the issuing module 11 receives content purchase requests from users (terminal devices 20 and 201 to 20N). As a result, the issuing module 11 executes a payment process (billing process) in the legal currency, the virtual currency, or the like possessed by the user. After completion of the billing process, the issuing module 11 transmits an issuing request for an NFT corresponding to the purchased content to the blockchain network 30.

For example, the issuing module 11 transmits (uploads) information specifying that this is a game content, information specifying the owner, and the like to the blockchain network 30 together with an issuing request for an NFT. As a result, an NFT corresponding to the content is issued in the blockchain network 30. The issuing module 11 transmits the NFT corresponding to the content to a wallet (terminal device) of the purchaser (user).

The information regarding the content to be sold may be stored in the storage device of the server device 10B. In a case where a plurality of contents are sold, a list of the contents to be sold may be transmitted to the terminal device 20 to allow the user to select the content to be purchased.

The acquisition module 12 acquires the transaction information of the secondary distribution for each NFT corresponding to a content in the blockchain network 30. The transaction information is, for example, the transaction history described above. For example, the acquisition module 12 may request the blockchain network 30 to transmit the transaction history of the content (NFT) having identification information specifying the game.

The granting module 13B grants an in-game privilege to a user of the game in a case where a granting condition related to the transaction information of the secondary distribution is satisfied. The granting module 13B in the example of the present embodiment grants an in-game privilege to the user who is the current owner and the user who was the past owner for the NFT corresponding to the content for which the granting condition related to the transaction information is satisfied. The granting condition includes, for example, a condition that the number of transactions (the number of concluded contracts) has reached a predetermined number (for example, 10 times) or more. As described above, in a case where the total number of transfers of an NFT corresponding to one content has reached a predetermined number or more, the granting condition for the NFT is set to be satisfied. The granting module 13B may determine whether the granting condition is satisfied from the transaction history of an NFT corresponding to the content to be determined. The granting module 13B determines whether the granting condition is satisfied for each of the NFTs corresponding to all the contents.

As described above, the target persons to whom the in-game privilege is granted are the user who is the current owner and the user who was the past owner for the NFT corresponding to the content for which the granting condition is satisfied. That is, the user is a user having a game user ID that has been registered in the server device 10B (storage device) among the current owner and the past owner. Regarding identification information (user ID) of the current owner and identification information (user ID) of the past owner, the transaction history of the NFT corresponding to the content for which the granting condition has been satisfied may be referred. The transaction history includes user IDs specifying a transferor and a transferee from the original owner to the current owner. In this case, the granting module 13B may perform granting, for example, at a timing when each corresponding user has logged in. In a case where the corresponding user logs in, privilege information may be added to the owned items included in user data of this user.

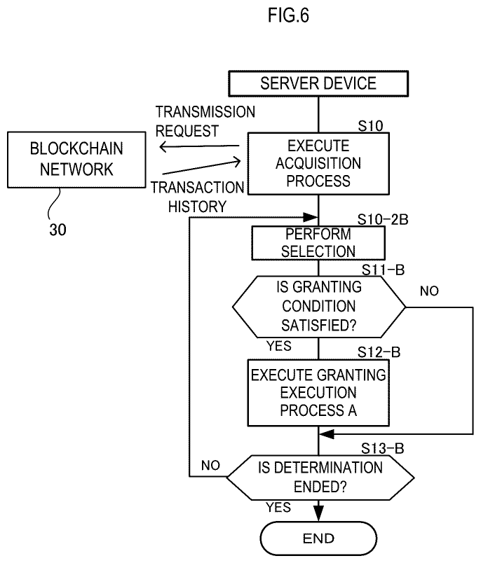

FIG. 6 is a flowchart illustrating an example of a granting process executed by the system 100. The granting process in the example of the present embodiment is a process for granting an in-game privilege. FIG. 6 mainly illustrates a process for acquiring transaction information and a process for granting an in-game privilege to the user, and other processes may be partially omitted.

The granting process in the example of the present embodiment is repeatedly executed, for example, every time a predetermined period of time has elapsed (for example, 24 hours have elapsed).

The server device 10B executes an acquisition process of a transaction history (Step S10). In the acquisition process, for example, the server device 10B transmits a transmission request of a transaction history to the blockchain network 30 together with identification information specifying the game. As a result, the transaction histories of NFTs corresponding to all the contents are transmitted from the blockchain network 30 to the server device 10B.

Then, the server device 10B selects a transaction history of one NFT for which the granting condition has not been determined (Step S10-2B). The server device 10B determines whether or not the granting condition is satisfied with reference to the selected transaction history of the one NFT (Step S11-B). In a case where the granting condition is not satisfied (Step S11-B: NO), the server device 10B proceeds to the process of Step S13-B.

On the other hand, in a case where the granting condition is satisfied (Step S11-B: YES), the server device 10B executes a granting execution process A (Step S12-B). In the granting execution process A, an in-game privilege is granted to the user. The server device 10B, for example, refers to the transaction history selected in the process of Step 10-2B, and specifies the user (user ID) who is the current owner of the NFT corresponding to the content in this transaction history and the user (user ID) who was the past owner. In the granting execution process A, for example, the server device 10B performs settings such that an in-game privilege is granted when each of the specified users has logged in. Specifically, the specified user (game user ID) may be set in the storage device as a user to whom the in-game privilege is to be granted.

Then, the server device 10B determines whether or not determination of the granting condition has been ended for NFTs corresponding to all contents (Step S13-B). In a case where it is determined that the determination has not ended (Step S13-B: NO), the server device 10B returns to the process of Step S10-2B and newly selects the transaction history of one NFT for which the granting condition has not been determined. On the other hand, in a case where it is determined that the determination has ended (Step S13-B: YES), the server device 10B ends the granting process.

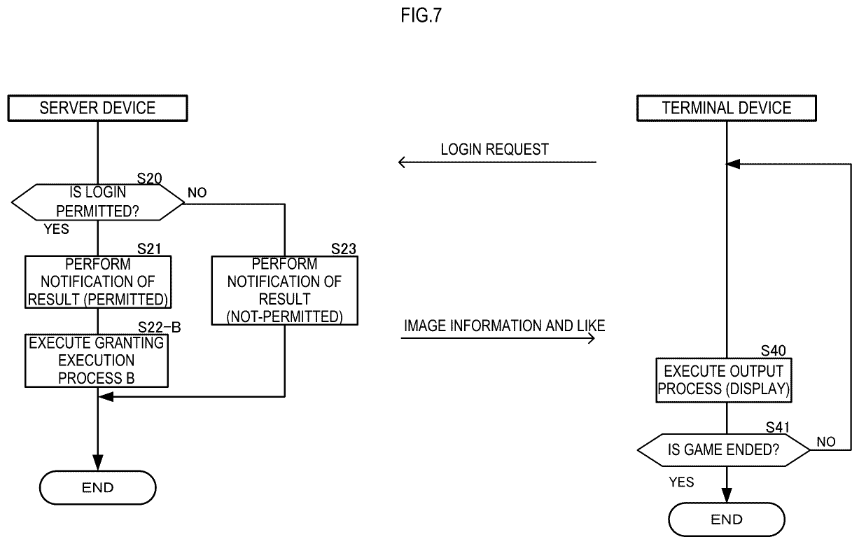

FIG. 7 is a flowchart illustrating an example of a login process executed by the system 100. The login process in the example of the present embodiment is a process for authenticating the user. FIG. 7 mainly illustrates a process for granting the in-game privilege to the user who has logged in, and other processes may be partially omitted. A case where the server device 10B and the terminal device 20 of a user P execute the login process will be described below as an example.

Execution of the login process in the example of the present embodiment is started, for example, in a case where the terminal device 20 issues a login request. The terminal device 20 transmits a login request to the server device 10B together with authentication information such as the game user ID and the authentication password of the user P, for example.

The server device 10B determines whether or not to permit the login (Step S20). For example, the server device 10B may perform authentication by comparing the received authentication information with the game user ID or the like included in the user data stored in the storage device. In a case where the login is not permitted (Step S20: NO), the server device 10B may, for example, transmit, to the terminal device 20, image information for a notification of the result that the login is not permitted (Step S23). Thereafter, the server device 10B ends the login process.

On the other hand, in a case where the login is permitted (Step S20: YES), the server device 10B may, for example, transmit, to the terminal device 20, image information for a notification of the result that the login is permitted (Step S21). Then, the server device 10B executes a granting execution process B (Step S22-B). In the granting execution process B, in a case where the user P is a user to whom an in-game privilege is scheduled to be granted, the server device 10B adds privilege information (for example, item identification information) to the owned item in the user data (storage device) of the user P. For example, by comparing the game user ID of the user P with the game user ID of the user scheduled to be the target person to whom granting is performed, it is determined whether or not the user is a granting target person.

In the granting execution process B, in a case where the in-game privilege is granted, for example, image information for a notification indicating that the in-game privilege has been granted is transmitted from the server device 10B to the terminal device 20. Thereafter, the server device 10B ends the login process.

On the other hand, the terminal device 20 displays (outputs) the game image based on the image information and the like received from the server device 10B on the display until the execution of the game is ended (Step S41: YES) (Step S40). In a case where the in-game privilege has been granted, the terminal device 20 displays a game image for a notification indicating that the in-game privilege has been granted.

Although the login process illustrated in FIG. 7 has been described with respect to the terminal device 20, the similar process may be executed for other users (terminal devices).

As described above, as one aspect of the second embodiment, the server device 10B is configured to include the issuing module 11, the acquisition module 12, and the granting module 13B. Thus, the in-game privilege is granted in accordance with the transaction status of the NFT corresponding to the content in the game. Thus, the NFT transaction and the game play are configured to be more associated with each other, and thus it is possible to improve the interest of the game.

In addition, since the in-game privilege is granted to the user involved in the transaction of the NFT corresponding to the content used in the game, it is possible to improve the willingness of the user to perform both an NFT transaction and the game play.

In the example in the embodiment described above, the configuration in which the in-game privilege is granted to the user who is the current owner and the user who was the past owner has been described as an example, but the present embodiment is not particularly limited to this. For example, the in-game privilege may be granted only to the user who is the current owner, or only to the past owner. Furthermore, another condition may be added. For example, an in-game privilege may be granted only to the original owner of the NFT corresponding to the content among the past owners. Further, for example, the in-game privilege may be granted only to a user among the past owners who has logged in to the game within a predetermined period after the granting condition is satisfied.

Games of various genres can be adopted as the video game in the example in the above-described embodiment as long as the contents such as the characters are used in the game.

Regarding the content in the example in the above-described embodiment, a plurality of the same contents may be provided, or contents of different types may be provided.

As described above, the issuing module in the example in the above-described embodiment may be configured to issue an NFT request to the blockchain network to issue an NFT, or may be configured to issue an NFT itself. Further, the NFT issuance by the issuing module also includes a configuration in which an issued NFT corresponding to the content, the owner of the NFT being an operator of the game, is transferred to the user.

In the example in the embodiment described above, a configuration in which an NFT is issued when a content in the game is purchased by the user has been described, but the subject of NFT issuance is not particularly limited to this. The content may be acquired by the user, and may be, for example, acquired (given) to the user as a result of playing the game.

In the example in the embodiment described above, the number of transactions in the transaction history has been described as the transaction information, but the transaction information is not particularly limited to this as long as the transaction information is information associated with a transaction of the secondary distribution. For example, the transaction information may be a transaction price. The transaction price is included in the transaction history of the NFT. In this case, for example, a granting condition in which the total transaction price has reached a predetermined amount or more may be set. Further, for example, a granting condition in which there is a transaction concluded at a predetermined transaction price or more may be set.

In the example in the embodiment described above, only one granting condition is provided, but a plurality of conditions may be provided. For example, conditions A, B, and C may be provided as the granting conditions. In this case, in a case where any one of the conditions A, B, and C is satisfied, the in-game privilege may be granted on the assumption that the granting condition has been satisfied. Alternatively, in a case where all the conditions A, B, and C are satisfied, the in-game privilege may be granted on the assumption that the granting condition has been satisfied. Also, the granting condition may be changed periodically.

In the example in the embodiment described above, the in-game privilege may be a token that can be used only in the game, but may be an NFT. In this case, the server device (issuing module) may issue an NFT corresponding to the in-game privilege with the user to whom the in-game privilege is to be granted as the owner.

The in-game privilege of the example in the above-described embodiment is not limited to the privilege described above. For example, a privilege associated with the above game in other systems may be set as the in-game privilege. Another system is a system capable of providing a predetermined service related to the game to each user. For example, a role on the server related to the game on Discord corresponds to the in-game privilege. In this case, Discord is the other system. On the Discord, the server means a community on a network, which is established by voice channels and the like. For example, on Discord, the server related to the game is a community for the game created by the operator of the game. The role means a post (role) in the server, and an authority in the server is set for each type of role. For example, on the server related to the game on Discord, a role in which an authority to create a public thread or the like is set is granted to the user as an in-game privilege.

In the case of the above example, the game system (the server device), for example, may communicably cooperate with another system via a communication network, and transmit the roll (in-game privilege) setting request (granting request) to the other system when the user has logged in.

As described above, granting a privilege associated with the game in another system as the in-game privilege contributes to increasing the motivation of the user who plays the game.

In the example in the embodiment described above, the transaction information of the NFT corresponding to the content is used for the entire period from the past to the present, but the present embodiment is not particularly limited to this. The granting condition may be determined by using transaction information for a specific period (for example, a period from the present to one year ago).

In the example in the embodiment described above, all pieces of transaction information of the NFT corresponding to the content used in the game are acquired, but the present embodiment is not particularly limited to this. For example, some pieces of transaction information of the NFTs may be acquired. In this case, information (granting target information) for specifying a target of the transaction information may be registered in the metadata of a target NFT. Then, the blockchain network may be requested to transmit the transaction information of the NFT including the granting target information.

In the example in the embodiment described above, the operating entity of the server device and the operating entity of the blockchain network may be different or the same.

### Third Embodiment

FIGS. 8A and 8B are schematic diagrams illustrating an example of an NFT character according to at least one embodiment of the present disclosure. In the example of the present embodiment, a game in which a plurality of missions to search for an object as a specific character or a landmark are prepared in a game space (virtual space) is provided. In the game, it is also possible to use a NFT character. A hint for completing the mission is associated with the NFT character. Thus, a user acquires and uses an NFT character for one purpose of facilitating the completion of the mission.

The NFT character is a character for which an NFT has been issued. The character corresponds to a content used in the game. The NFT character is associated with a token ID, and the token ID is associated with metadata, a transaction history, and the like. The metadata includes information specifying that this is the game content, information specifying the owner, granting target information, and the like.

In the example of the present embodiment, there are a character having metadata that does not include the granting target information as illustrated in FIG. 8A, and a specific character having metadata including the granting target information as illustrated in FIG. 8B, the specific character (NFT) is a character that is used as a reference for granting an in-game privilege. The specific character is marked with a star, for example, as illustrated in FIG. 8B. Details will be described later.

In the game in the example of the present embodiment, a plurality of characters for which NFTs are issued are sold, and when a user makes a purchase, an NFT corresponding to the character is issued with the user who made the purchase as the owner. In-game currency is used for the purchase, for example. The in-game currency may be purchased by consuming legal currency, for example. The user can make the above purchase by a purchase operation during the execution of the game on the terminal device of the user. The NFT corresponding to the character can be traded (secondary distribution) on the NFT marketplace (blockchain network 30).

In the example of the present embodiment, an in-game privilege is granted to the user of the game in accordance with transaction information (transaction status) of the secondary distribution of the NFT corresponding to the character. Specifically, in a case where the granting condition related to the transaction information is satisfied, an in-game privilege is granted to the user of the game. The transaction information of the secondary distribution corresponds to the transaction history recorded in the blockchain of the NFT corresponding to the character. The transaction history includes the transfer date and time, the transfer amount, and the like in addition to pieces of identification information (user ID) of the transferor and the transferee for the character.

The granting condition is that the number of transactions (the number of concluded contracts) has reached a predetermined number (for example, 10000 times) or more. In the example of the present embodiment, the granting condition is determined by using an NFT corresponding to a specific character as the target among NFTs corresponding to all characters. The NFT corresponding to the specific character is an NFT corresponding to a character having granting target information. That is, in a case where the total number of transfers (the number of transactions) of NFTs corresponding to all specific characters has reached a predetermined number or more, the granting condition is set to be satisfied. For example, if the total number of NFT transactions corresponding to all 10 specific characters is 15000, it is determined that the granting condition is satisfied.

Examples of the in-game privilege include a recovery item. The recovery item has an effect of recovering points consumed when the user plays the mission. The in-game privilege is granted only to a user who has satisfied a target person condition among all users of the game. The target person condition is, for example, a user who has logged in (played the game) within a predetermined period (for example, one month) after the granting condition is satisfied.

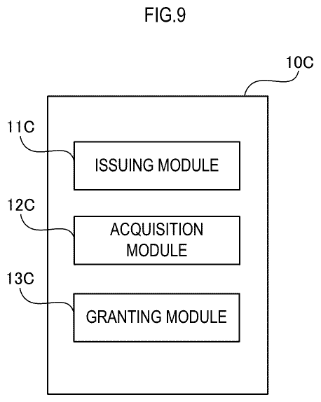

FIG. 9 is a block diagram illustrating a configuration of a server device 10C that is an example of the server device 10. In the example of the present embodiment, the server device 10C includes at least an issuing module 11C, an acquisition module 12C, and a granting module 13C.

The issuing module 11C issues an NFT corresponding to a character, with the user who is the acquirer (purchaser) of the content (character) as the owner. The issuing module 11C also has a sales function. The issuing module 11C displays, for example, a game image of a list of sellable characters on the terminal devices 20 and 201 to 20N of the users. The user may select a character desired to be purchased by operating the terminal device of the user. The information regarding the content to be sold may be stored in the storage device of the server device 10C.

When the issuing module 11C receives a purchase request for the selected character from the user (terminal device), the issuing module 11C executes a payment process (billing process) with the in-game currency possessed by the user. After completion of the billing process, the issuing module 11C transmits an issuing request for an NFT corresponding to the purchased content to the blockchain network 30. The issuing module 11C transmits (uploads) information specifying that this is a character of the game, information specifying the owner, granting target information, and the like to the blockchain network 30 together with an issuing request for an NFT. As a result, an NFT corresponding to the character is issued in the blockchain network 30. The issuing module 11C transmits the NFT corresponding to the character to a wallet (terminal device) of the purchaser (user).

The information specifying that this is the character of the game includes, for example, identification information (game ID) specifying the game and identification information (character ID) specifying the character in the example of the present embodiment. Each piece of identification information is stored in the storage device of the server device 10C.

The information specifying the owner is identification information (user ID) of the user who has purchased (acquired) the content. The user ID is a wallet address of the user (terminal device), for example. The user ID is also stored in a server device 10C as user data of the user.

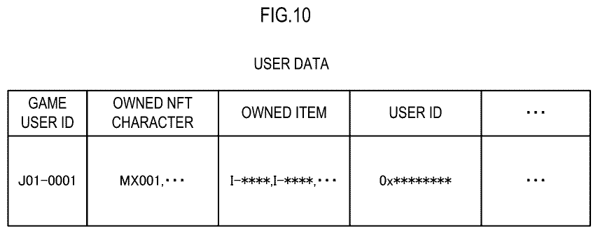

The user data is data regarding the game of the user, and is stored in the storage device of the server device 10C for each user. FIG. 10 is a diagram illustrating an example of user data of one user. The user data is configured by fields of a game user ID, an owned NFT character, an owned item, a user ID, and the like.

Identification information of the user for the game is set in the field of the game user ID. Identification information (character ID) of the NFT character stored in a wallet of the user is set in the field of the owned NFT character. The user can use the NFT character set in the field of the owned NFT character, in the game. Identification information (item ID) of an item owned by the user is set in the field of the owned item. The user can use the item set in the field of the owned item, in the game.

The above-described identification information (user ID) of the user is set in the field of the user ID. That is, information specifying the owner of the NFT described above is set in the field of the user ID. A wallet address of the user (terminal device) is set in the field of the user ID.

Next, the granting target information is identification information indicating the content (specific character) to which the in-game privilege is to be granted, as described above. The granting target information is stored in the storage device of the server device 10C in association with the character ID. In a case where the purchased character (character ID) is associated with the granting target information, the issuing module 11C transmits (uploads) an issuing request including the granting target information to the blockchain network 30. On the other hand, in a case where the purchased character (character ID) is not associated with the granting target information, the issuing request is transmitted to the blockchain network 30 without the granting target information.

Whether or not the character is a specific character may be determined based on the attributes of the character or the like. The attributes are, for example, properties and characteristics set to a character, such as rarity and a job. For example, in a case where the job of the purchased character is a swordsman, an issuing request including the granting target information may be set to be transmitted (uploaded) to the blockchain network 30.

The acquisition module 12C acquires the transaction information of the secondary distribution for each NFT corresponding to the character in the blockchain network 30. The transaction information is the transaction history described above. The acquisition module 12C requests the blockchain network 30 to transmit the transaction history of the content (NFT) having identification information specifying the game and the granting target information. That is, the acquisition module 12C requests the blockchain network 30 to transmit the transaction history of the NFT corresponding to the specific character.

The granting module 13C grants an in-game privilege to a user of the game in a case where a granting condition related to the transaction information of the secondary distribution is satisfied. As described above, the granting condition is that the number of transactions (the number of concluded contracts) has reached a predetermined number (for example, 10000 times) or more. The granting module 13C determines the granting condition from the transaction history of the NFT corresponding to the specific character (the specific content). That is, in a case where the total number of transfers (the number of transactions) of NFTs corresponding to all specific characters has reached a predetermined number or more, it is determined that the granting condition is satisfied.

A target person to whom the in-game privilege is granted is a user who has satisfied the target person condition as described above. The target person condition includes a user who has logged in (played the game) within a predetermined period (for example, one month) after the granting condition is satisfied. In a case where the user has logged in, the granting module 13C determines whether or not the current time when login has been performed is within a predetermined period (target person condition). The granting module 13C grants an in-game privilege to the user in a case where the current time when login has been performed is within the predetermined period. Specifically, the granting module 13C additionally sets an item ID of the in-game privilege to the field of the owned item in the user data of this user.

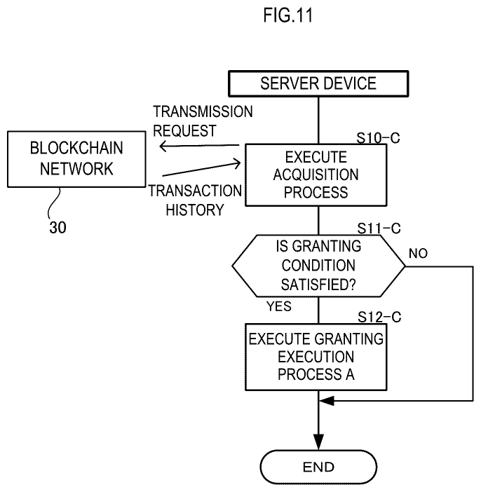

FIG. 11 is a flowchart illustrating an example of a granting process executed by the system 100. The granting process in the example of the present embodiment is a process for granting an in-game privilege. FIG. 11 mainly illustrates a process for acquiring transaction information and a process for granting an in-game privilege to the user, and other processes may be partially omitted.

The granting process in the example of the present embodiment is repeatedly executed, for example, every time a predetermined period of time has elapsed (for example, 24 hours have elapsed).

The server device 10C executes an acquisition process of a transaction history (Step S10-C). In the acquisition process, the blockchain network 30 is requested to transmit the transaction history of the NFT corresponding to the specific content. Specifically, the server device 10C transmits a transmission request of the transaction history to the blockchain network 30 together with identification information (game ID) specifying the game and the granting target information. As a result, only the transaction history of the NFT corresponding to the specific content is transmitted from the blockchain network 30 to the server device 10C.

Then, the server device 10C determines whether or not the granting condition is satisfied (Step S11-C). The server device 10C may determine whether or not the granting condition is satisfied with reference to all acquired transaction histories. In a case where the granting condition is not satisfied (Step S11-C: NO), the server device 10C ends the granting process.

On the other hand, in a case where the granting condition is satisfied (Step S11-C: YES), the server device 10C executes a granting execution process A (Step S12-C). In the granting execution process A, a process for granting an in-game privilege to the user is executed. Specifically, the server device 10C performs setting such that the in-game privilege is granted to the user who has logged in before a predetermined period elapses. The privilege granting timing is when the user logs in. In addition, in the granting execution process A, the server device 10C sets a start time and an end time of the predetermined period in the storage device. Thereafter, the server device 10C ends the granting process.

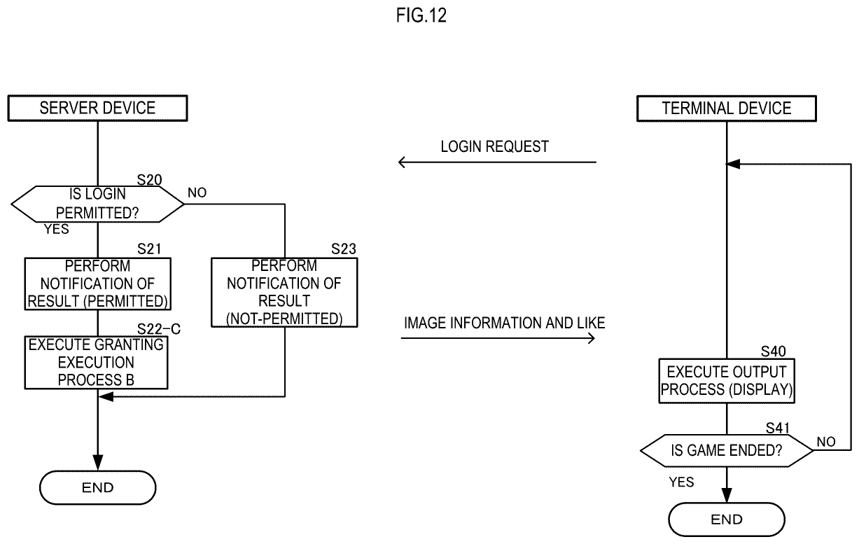

FIG. 12 is a flowchart illustrating an example of a login process executed by the system 100. The login process in the example of the present embodiment is a process for authenticating the user. FIG. 12 mainly illustrates a process for granting the in-game privilege to the user who has logged in, and other processes may be partially omitted. A case where the server device 10C and the terminal device 20 of a user P execute the login process will be described below as an example.

Execution of the login process in the example of the present embodiment is started, for example, in a case where the terminal device 20 issues a login request. The terminal device 20 transmits a login request to the server device 10C together with authentication information such as the game user ID and the authentication password of the user P, for example.

The server device 10C determines whether or not to permit the login (Step S20). For example, the server device 10C may perform authentication by comparing the received authentication information with the game user ID or the like included in the user data stored in the storage device. In a case where the login is not permitted (Step S20: NO), the server device 10C may, for example, transmit, to the terminal device 20, image information for a notification of the result that the login is not permitted (Step S23). Thereafter, the server device 10C ends the login process.

On the other hand, in a case where the login is permitted (Step S20: YES), the server device 10C may, for example, transmit, to the terminal device 20, image information for a notification of the result that the login is permitted (Step S21). Then, the server device 10C executes a granting execution process B (Step S22-C). In the granting execution process B, an in-game privilege is granted to the user P in a case where the current time is within a predetermined period. Specifically, the server device 10C additionally sets an item ID of the in-game privilege in the field of the owned item in the user data of the user P (storage device). In the granting execution process B, in a case where the in-game privilege is granted, for example, image information for a notification indicating that the in-game privilege has been granted is transmitted from the server device 10C to the terminal device 20. Thereafter, the server device 10C ends the login process. In a case where the current time is not within the predetermined period, the server device 10C ends the granting execution process B without granting the in-game privilege.

The in-game privilege is granted only once. The server device 10C may store, for example, the user (game user ID) to whom the in-game privilege is granted, in the storage device. Then, in a case where the game user ID of the logged-in user is already included in the game user IDs to which the in-game privilege has been granted, the server device 10C may end the granting execution process B without granting the in-game privilege.

On the other hand, the terminal device 20 displays the game image based on the image information and the like received from the server device 10C on the display until the execution of the game is ended (Step S41: YES) (Step S40). In a case where the in-game privilege has been granted, the terminal device 20 displays a game image for a notification indicating that the in-game privilege has been granted.

Although the login process illustrated in FIG. 12 has been described with respect to the terminal device 20, the similar process may be executed for other users (terminal devices).

As described above, as one aspect of the third embodiment, the server device 10C is configured to include the issuing module 11C, the acquisition module 12C, and the granting module 13C. Thus, the in-game privilege is granted in accordance with the transaction status of the NFT corresponding to the content in the game. Therefore, the NFT transaction and the game play are configured to be more associated with each other, and thus it is possible to improve the interest of the game.

In addition, since the transaction information (transaction status) to be acquired is limited to the NFT corresponding to the specific content, the amount of data to be acquired from the blockchain network is reduced. Thus, it is possible to suppress an increase in processing load on the blockchain network.

In the example of the embodiment described above, the granting target information is recorded in the blockchain separately from other types of information, but other types of information may be used as the granting target information. For example, a character ID may be used as the granting target information. Specifically, the granting target information is stored in the storage device of the server device in association with the character ID. The granting module may transmit a transmission request of the transaction history to the blockchain network together with the game ID and the character ID associated with the granting target information. As a result, only the transaction history of the NFT corresponding to the specific content is transmitted from the blockchain network to the server device.

Games of various genres can be adopted as the video game in the example in the above-described embodiment as long as the contents such as the characters are used in the game.

Regarding the content (characters) in the example in the above-described embodiment, a plurality of the same contents may be provided, or contents of different types may be provided.

The issuing module in the example in the above-described embodiment may be configured to issue an NFT request to the blockchain network to issue an NFT, or may be configured to issue an NFT itself. Further, the NFT issuance by the issuing module also includes a configuration in which an issued NFT corresponding to the content, the owner of the NFT being an operator of the game, is transferred to the user.

In the example in the embodiment described above, a configuration in which an NFT is issued when a content in the game is purchased by the user has been described, but the subject of NFT issuance is not particularly limited to this. The content may be acquired by the user, and may be, for example, acquired (given) to the user as a result of playing the game.

In the example in the embodiment described above, the number of transactions in the transaction history has been described as the transaction information, but the transaction information is not particularly limited to this as long as the transaction information is information associated with a transaction of the secondary distribution. For example, the transaction information may be a transaction price. The transaction price is included in the transaction history of the NFT. In this case, for example, a granting condition in which the total transaction price has reached a predetermined amount or more may be set. Further, for example, a granting condition in which there is a transaction concluded at a predetermined transaction price or more may be set.

In the example in the embodiment described above, only one granting condition is provided, but a plurality of conditions may be provided. For example, conditions A, B, and C may be provided as the granting conditions. In this case, in a case where any one of the conditions A, B, and C is satisfied, the in-game privilege may be granted on the assumption that the granting condition has been satisfied. Alternatively, in a case where all the conditions A, B, and C are satisfied, the in-game privilege may be granted on the assumption that the granting condition has been satisfied. Also, the granting condition may be changed periodically.

In the example in the embodiment described above, the in-game privilege may be a token that can be used only in the game, but may be an NFT. In this case, the server device (issuing module) may issue an NFT corresponding to the in-game privilege with the user to whom the in-game privilege is to be granted as the owner.

In the example of the embodiment described above, the target person condition is provided, but all users of the game may be set as targets for granting the in-game privilege without providing the target person condition. Also, the target person condition may be set to include a plurality of conditions, similar to the granting condition. For example, a condition of owning an NFT corresponding to a specific content may be included in the target person condition. The specific content may be set to, for example, an NFT corresponding to the content (character) including the granting target information in the example of the present embodiment.

The start time and the end time of the predetermined period in the example of the above-described embodiment may be any time after the granting condition is satisfied.

The in-game privilege of the example in the above-described embodiment is not limited to the privilege described above. For example, a privilege associated with the above game in other systems may be set as the in-game privilege. Another system is a system capable of providing a predetermined service related to the game to each user. For example, a role on the server related to the game on Discord corresponds to the in-game privilege. In this case, Discord is the other system. On Discord, the server means a community on a network, which is established by voice channels and the like. For example, on Discord, the server related to the game is a community for the game created by the operator of the game. The role means a post (role) in the server, and an authority in the server is set for each type of role. For example, on the server related to the game on Discord, a role in which an authority to create a public thread or the like is set is granted to the user as an in-game privilege.

In the case of the above example, the game system (the server device), for example, may communicably cooperate with another system via a communication network, and transmit the roll (in-game privilege) setting request (granting request) to the other system when the user has logged in.

As described above, granting a privilege associated with the game in another system as the in-game privilege contributes to increasing the motivation of the user who plays the game.

In the example in the embodiment described above, the transaction information of the NFT corresponding to the content is used for the entire period from the past to the present, but the present embodiment is not particularly limited to this. The granting condition may be determined by using transaction information for a specific period (for example, a period from the present to one year ago).

In the example of the embodiment described above, the transaction information of the NFT corresponding to the specific content is acquired, but the present embodiment is not particularly limited to this. The server device may acquire pieces of transaction information of NFTs corresponding to all contents, and determine the granting conditions with reference to only the necessary transaction information.

In the example in the embodiment described above, the operating entity of the server device and the operating entity of the blockchain network may be different or the same.

### Fourth Embodiment

Regarding a game in the example of the present embodiment, a game in which a plurality of missions to search for an object as a specific character or a landmark are prepared in a game space (virtual space) is provided similar to the example of the third embodiment. In the game, it is also possible to use a NFT character. A hint for completing the mission is associated with the NFT character. Thus, a user acquires and uses an NFT character for one purpose of facilitating the completion of the mission. The NFT character is similar to that in the example of the third embodiment.

The sale of a plurality of NFT characters is similar to that in the example of the third embodiment. When a user makes a purchase, an NFT corresponding to a character is issued with the user who made the purchase as the owner. The NFT corresponding to the character can be traded (secondary distribution) on the NFT marketplace (blockchain network 30).

In the example of the present embodiment, an in-game privilege is granted to the user of the game in accordance with transaction information (transaction status) of the secondary distribution of the NFT corresponding to the character. Specifically, in a case where the granting condition related to the transaction information is satisfied, an in-game privilege is granted to the user of the game. The transaction information of the secondary distribution corresponds to the transaction history recorded in the blockchain of the NFT corresponding to the character. The transaction history includes the transfer date and time, the transfer amount, and the like in addition to pieces of identification information (user ID) of the transferor and the transferee for the character.

In the example of the present embodiment, the configuration of granting the in-game privilege is different from that in the example of the third embodiment. First, the granting condition is that the number of transactions (the number of concluded contracts) has reached a predetermined number (for example, 10 times) or more. Further, in the example of the present embodiment, whether the granting condition is satisfied is determined for each NFT corresponding to the character. The transaction history of the NFT corresponding to the character to be determined is referred to for determination of the granting condition.

In addition, in the example of the present embodiment, the granting condition is determined by using an NFT corresponding to a specific character as the target among NFTs corresponding to all characters. The NFT corresponding to the specific character is an NFT corresponding to a character having granting target information. That is, in a case where the total number of transfers (the number of transactions) of an NFT corresponding to one specific character has reached a predetermined number or more, the granting condition for the NFT is set to be satisfied. For example, it is determined whether the granting condition is satisfied by referring only to the transaction history of an NFT corresponding to a specific character C1, and it is determined whether the granting condition is satisfied by referring only to the transaction history of an NFT corresponding to a specific character C2. Also, for example, even in a case where there are a plurality of NFTs corresponding to the same specific character, it is determined whether the granting condition is satisfied for each NFT corresponding to the same specific character.

The in-game privilege is granted to the user who has satisfied the target person condition among the user who is the current owner and the user who was the past owner for the NFT corresponding to the content (the specific character) for which the granting condition has been satisfied. That is, the user is a user having a game user ID that has been registered in the server device 10D (storage device) among the current owner and the past owner. The in-game privilege is granted to the user who has satisfied the target person condition among these users.

The in-game privilege is a recovery item, as in the example of the third embodiment. The target person condition is, for example, a user who has logged in (played the game) within a predetermined period (for example, one month) after the granting condition is satisfied. That is, in a case where the user who is the current owner and the user of the game who was the past owner for the corresponding NFT has logged in within the predetermined period, the in-game privilege is granted.

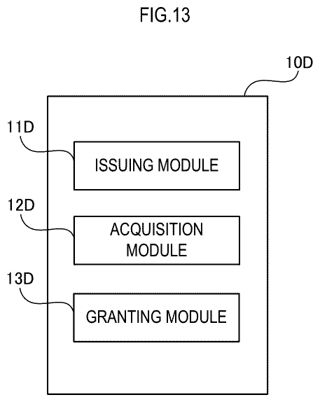

FIG. 13 is a block diagram illustrating a configuration of a server device 10D that is an example of the server device 10. In the example of the present embodiment, the server device 10D includes at least an issuing module 11D, an acquisition module 12D, and a granting module 13D.

The issuing module 11D is similar to the issuing module 11C in the third embodiment, and issues an NFT corresponding to a character with the user who is the acquirer (purchaser) of the content (character) as the owner. The issuing module 11D also has a sales function. The issuing module 11D displays, for example, a game image of a list of sellable characters on the terminal devices 20 and 201 to 20N of the users. The user may select a character desired to be purchased by operating the terminal device of the user. The information regarding the content to be sold may be stored in the storage device of the server device 10D.

When the issuing module 11D receives a purchase request for the selected character from the user (terminal device), the issuing module 11D executes a payment process (billing process) with the in-game currency possessed by the user. After completion of the billing process, the issuing module 11D transmits an issuing request for an NFT corresponding to the purchased content to the blockchain network 30. The issuing module 11D transmits (uploads) information specifying that this is a character of the game, information specifying the owner, granting target information, and the like to the blockchain network 30 together with an issuing request for an NFT. As a result, an NFT corresponding to the character is issued in the blockchain network 30. The issuing module 11D transmits the NFT corresponding to the character to a wallet (terminal device) of the purchaser (user).

The information specifying that this is the character of the game includes, for example, identification information (game ID) specifying the game and identification information (character ID) specifying the character in the example of the present embodiment. Each piece of identification information is stored in the storage device of the server device 10D.

The information specifying the owner is identification information (user ID) of the user who has purchased (acquired) the content. The user ID is a wallet address of the user (terminal device), for example. The user ID is also stored in the server device 10D as user data of the user.

The user data is data regarding the game of the user, and is stored in the storage device of the server device 10D for each user. The user data is similar to that in the example of the third embodiment, and is configured by fields of a game user ID, an owned NFT character, an owned item, a user ID, and the like (see FIG. 10, for example).

Next, similar to the example of the third embodiment, the granting target information is identification information indicating the content (specific character) to which the in-game privilege is to be granted. The granting target information is stored in the storage device of the server device 10D in association with the character ID. In a case where the purchased character (character ID) is associated with the granting target information, the issuing module 11D transmits (uploads) an issuing request including the granting target information to the blockchain network 30. On the other hand, in a case where the purchased character (character ID) is not associated with the granting target information, the issuing request is transmitted to the blockchain network 30 without the granting target information.

The acquisition module 12D is similar to the acquisition module 12C in the third embodiment, and acquires transaction information of secondary distribution for each NFT corresponding to the character in the blockchain network 30. The transaction information is the transaction history described above. The acquisition module 12D requests the blockchain network 30 to transmit the transaction history of the content (NFT) having identification information specifying the game and the granting target information.

The granting module 13D grants an in-game privilege to a user of the game in a case where a granting condition related to the transaction information of the secondary distribution is satisfied. As described above, the granting condition is that the number of transactions (the number of concluded contracts) has reached a predetermined number (for example, 10 times) or more. The granting module 13D determines the granting condition for each transaction history of the NFT corresponding to the specific content (the specific character). That is, in a case where the total number of transfers of an NFT corresponding to one specific character has reached a predetermined number or more, the granting condition for the NFT is determined to be satisfied. The granting module 13D determines whether the granting condition is satisfied for each of the NFTs corresponding to all the specific contents.

The target person to whom the in-game privilege is granted is the user who is the current owner and the user who was the past owner for the NFT corresponding to the specific character for which the granting condition is satisfied, the current owner and the past owner satisfying the target person condition. The target person condition includes a user who has logged in (played the game) within a predetermined period (for example, one month) after the granting condition is satisfied. In a case where the corresponding user has logged in, the granting module 13D determines whether or not the current time when login has been performed is within a predetermined period (target person condition). The granting module 13D grants an in-game privilege to the corresponding user in a case where the current time when login has been performed is within the predetermined period. Specifically, the granting module 13D additionally sets an item ID of the in-game privilege to the field of the owned item in the user data of the corresponding user.

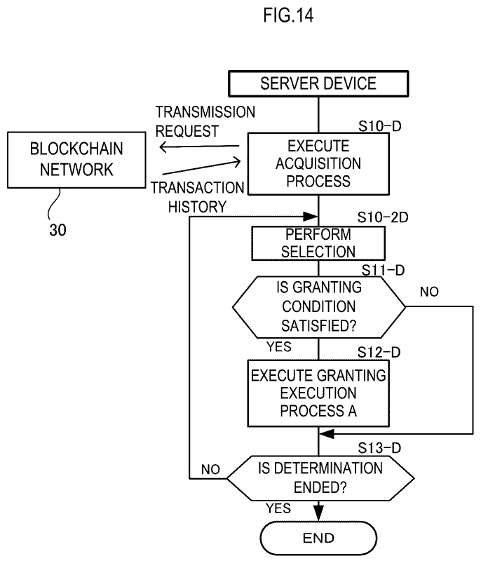

FIG. 14 is a flowchart illustrating an example of a granting process executed by the system 100. The granting process in the example of the present embodiment is a process for granting an in-game privilege. FIG. 14 mainly illustrates a process for acquiring transaction information and a process for granting an in-game privilege to the user, and other processes may be partially omitted.

The granting process in the example of the present embodiment is repeatedly executed, for example, every time a predetermined period of time has elapsed (for example, 24 hours have elapsed).

The server device 10D executes an acquisition process of a transaction history (Step S10-D). In the acquisition process, the blockchain network 30 is requested to transmit the transaction history of the NFT corresponding to the specific content. Specifically, the server device 10D transmits a transmission request of the transaction history to the blockchain network 30 together with identification information (game ID) specifying the game and the granting target information. As a result, only the transaction history of the NFT corresponding to the specific content is transmitted from the blockchain network 30 to the server device 10D.

Then, the server device 10D selects a transaction history of one NFT for which the granting condition has not been determined (Step S10-2D). The server device 10D determines whether or not the granting condition is satisfied with reference to the selected transaction history of the one NFT (Step S11-2D). In a case where the granting condition is not satisfied (Step S11-D: NO), the server device 10D proceeds to the process of Step S13-D.

On the other hand, in a case where the granting condition is satisfied (Step S11-D: YES), the server device 10D executes a granting execution process A (Step S12-D). In the granting execution process A, a process for granting an in-game privilege to the user is executed. The server device 10D refers to the transaction history selected in the process of Step 10-2D, and specifies the user (user ID) who is the current owner of the NFT corresponding to the content in this transaction history and the user (user ID) who was the past owner of the NFT corresponding to the content in this transaction. Then, the server device 10D performs setting such that the in-game privilege is granted to a user who has logged in before a predetermined period of time has elapsed among the specified users (user IDs). Specifically, the server device 10D sets, in the storage device, the start time and the end time of the predetermined period and the game user ID of the specified user (user ID) who is the user to whom the in-game privilege is scheduled to be granted.

Then, the server device 10D determines whether or not determination of the granting condition has been ended for NFTs corresponding to all specific contents (Step S13-D). In a case where it is determined that the determination has not ended (Step S13-D: NO), the server device 10D returns to the process of Step S10-2D and newly selects the transaction history of one NFT for which the granting condition has not been determined. On the other hand, in a case where it is determined that the determination has ended (Step S13-D: YES), the server device 10D ends the granting process.

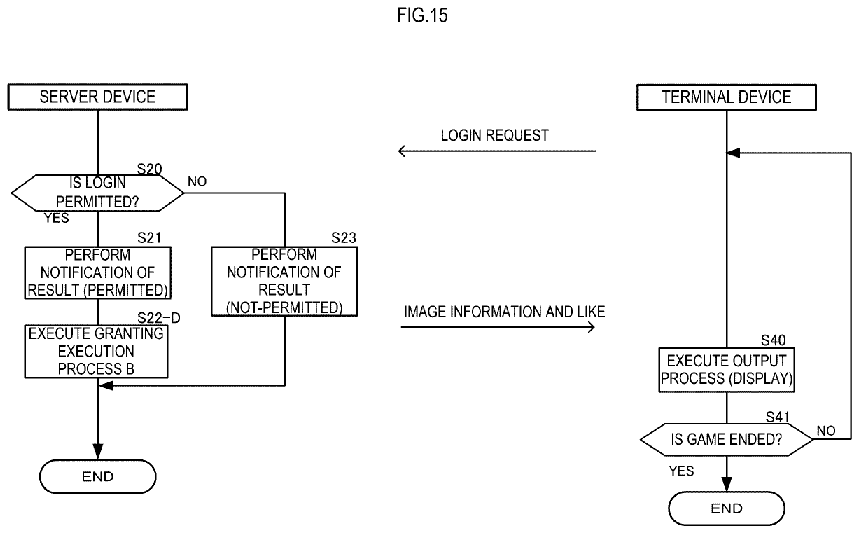

FIG. 15 is a flowchart illustrating an example of a login process executed by the system 100. The login process in the example of the present embodiment is a process for authenticating the user. FIG. 15 mainly illustrates a process for granting the in-game privilege to the user who has logged in, and other processes may be partially omitted. A case where the server device 10D and the terminal device 20 of a user P execute the login process will be described below as an example.

Execution of the login process in the example of the present embodiment is started, for example, in a case where the terminal device 20 issues a login request. The terminal device 20 transmits a login request to the server device 10D together with authentication information such as the game user ID and the authentication password of the user P, for example.

The server device 10D determines whether or not to permit the login (Step S20). For example, the server device 10D may perform authentication by comparing the received authentication information with the user ID or the like included in the user data stored in the storage device. In a case where the login is not permitted (Step S20: NO), the server device 10D may, for example, transmit, to the terminal device 20, image information for a notification of the result that the login is not permitted (Step S23). Thereafter, the server device 10D ends the login process.

On the other hand, in a case where the login is permitted (Step S20: YES), the server device 10D may, for example, transmit, to the terminal device 20, image information for a notification of the result that the login is permitted (Step S21). Then, the server device 10D executes a granting execution process B (Step S22-D). In the granting execution process B, the in-game privilege is granted to the user to whom the in-game privilege is scheduled to be granted, in a case where the current time is within the predetermined period. For example, in a case where the current time is within the predetermined period and the user P (game user ID) corresponds to a user (game user ID) to whom an in-game privilege is scheduled to be granted, the in-game privilege is granted to the user P. Specifically, the server device 10D additionally sets an item ID of the in-game privilege in the field of the owned item in the user data of the user P (storage device). In the granting execution process B, in a case where the in-game privilege is granted, for example, image information for a notification indicating that the in-game privilege has been granted is transmitted from the server device 10D to the terminal device 20. Thereafter, the server device 10D ends the login process. In a case where the current time is not within the predetermined period or in a case where the user who has logged in is not a granting candidate, the server device 10D ends the granting execution process B without granting the in-game privilege.

The in-game privilege is granted only once. The server device 10D may store, for example, the user (game user ID) to whom the in-game privilege is granted, in the storage device. Then, in a case where the game user ID of the logged-in user is already included in the game user IDs to which the in-game privilege has been granted, the server device 10D may end the granting execution process B without granting the in-game privilege.

On the other hand, the terminal device 20 displays the game image based on the image information and the like received from the server device 10D on the display until the execution of the game is ended (Step S41: YES) (Step S40). In a case where the in-game privilege has been granted, the terminal device 20 displays a game image for a notification indicating that the in-game privilege has been granted.

Although the login process illustrated in FIG. 15 has been described with respect to the terminal device 20, the similar process may be executed for other users (terminal devices).

As described above, as one aspect of the fourth embodiment, the server device 10D is configured to include the issuing module 11D, the acquisition module 12D, and the granting module 13D. Thus, the in-game privilege is granted in accordance with the transaction status of the NFT corresponding to the content in the game. Therefore, the NFT transaction and the game play are configured to be more associated with each other, and thus it is possible to improve the interest of the game.

In addition, since the transaction information (transaction status) to be acquired is limited to the NFT corresponding to the specific content, the amount of data to be acquired from the blockchain network is reduced. Thus, it is possible to suppress an increase in processing load on the blockchain network.

Furthermore, since the in-game privilege is granted to the user involved in the transaction of the NFT corresponding to the content used in the game, it is possible to improve the willingness of the user to perform both an NFT transaction and the game play.

In the example in the embodiment described above, the configuration in which the in-game privilege is granted to the user who is the current owner and the user who was the past owner has been described, but the present embodiment is not particularly limited to this. For example, the in-game privilege may be granted only to the user who is the current owner, or only to the past owner. Furthermore, another condition may be added. For example, an in-game privilege may be granted only to the original owner of the NFT corresponding to the content among the past owners. Further, for example, the in-game privilege may be granted only to a user among the past owners who has logged in to the game within a predetermined period after the granting condition is satisfied.

Games of various genres can be adopted as the video game in the example in the above-described embodiment as long as the contents such as the characters are used in the game.

Regarding the content (characters) in the example in the above-described embodiment, a plurality of the same contents may be provided, or contents of different types may be provided.

The issuing module in the example in the above-described embodiment may be configured to issue an NFT request to the blockchain network to issue an NFT, or may be configured to issue an NFT itself. Further, the NFT issuance by the issuing module also includes a configuration in which an issued NFT corresponding to the content, the owner of the NFT being an operator of the game, is transferred to the user.

In the example in the embodiment described above, a configuration in which an NFT is issued when a content in the game is purchased by the user has been described, but the subject of NFT issuance is not particularly limited to this. The content may be acquired by the user, and may be, for example, acquired (given) to the user as a result of playing the game.

In the example in the embodiment described above, the number of transactions in the transaction history has been described as the transaction information, but the transaction information is not particularly limited to this as long as the transaction information is information associated with a transaction of the secondary distribution. For example, the transaction information may be a transaction price. The transaction price is included in the transaction history of the NFT. In this case, for example, a granting condition in which the total transaction price has reached a predetermined amount or more may be set. Further, for example, a granting condition in which there is a transaction concluded at a predetermined transaction price or more may be set.

In the example in the embodiment described above, only one granting condition is provided, but a plurality of conditions may be provided. For example, conditions A, B, and C may be provided as the granting conditions. In this case, in a case where any one of the conditions A, B, and C is satisfied, the in-game privilege may be granted on the assumption that the granting condition has been satisfied. Alternatively, in a case where all the conditions A, B, and C are satisfied, the in-game privilege may be granted on the assumption that the granting condition has been satisfied. Also, the granting condition may be changed periodically.

In the example in the embodiment described above, the in-game privilege may be a token that can be used only in the game, but may be an NFT. In this case, the server device (issuing module) may issue an NFT corresponding to the in-game privilege with the user to whom the in-game privilege is to be granted as the owner.

In the example in the embodiment described above, the transaction information of the NFT corresponding to the content is used for the entire period from the past to the present, but the present embodiment is not particularly limited to this. The granting condition may be determined by using transaction information for a specific period (for example, a period from the present to one year ago).

In the example of the embodiment described above, the target person condition is provided, but all users of the game may be set as targets for granting the in-game privilege without providing the target person condition. Also, the target person condition may be set to include a plurality of conditions, similar to the granting condition. For example, a condition of owning an NFT corresponding to a specific content may be included in the target person condition. The specific content may be set to, for example, an NFT corresponding to the content (character) including the granting target information in the example of the present embodiment.

The start time and the end time of the predetermined period in the example of the above-described embodiment may be any time after the granting condition is satisfied.

The in-game privilege of the example in the above-described embodiment is not limited to the privilege described above. For example, a privilege associated with the above game in other systems may be set as the in-game privilege. Another system is a system capable of providing a predetermined service related to the game to each user. For example, a role on the server related to the game on Discord corresponds to the in-game privilege. In this case, Discord is the other system. on Discord, the server means a community on a network, which is established by voice channels and the like. For example, on Discord, the server related to the game is a community for the game created by the operator of the game. The role means a post (role) in the server, and an authority in the server is set for each type of role. For example, on the server related to the game on Discord, a role in which an authority to create a public thread or the like is set is granted to the user as an in-game privilege.

In the case of the above example, the game system (the server device), for example, may communicably cooperate with another system via a communication network, and transmit the roll (in-game privilege) setting request (granting request) to the other system when the user has logged in.

As described above, granting a privilege associated with the game in another system as the in-game privilege contributes to increasing the motivation of the user who plays the game.

In the example of the embodiment described above, the transaction history of the NFT corresponding to the specific content is acquired, but the present embodiment is not particularly limited to this. The server device may acquire transaction histories of NFTs corresponding to all contents, and determine the granting conditions with reference to only the necessary transaction history.

In the example in the embodiment described above, the operating entity of the server device and the operating entity of the blockchain network may be different or the same.

### Fifth Embodiment

Regarding a game in the example of the present embodiment, a game in which a plurality of missions to search for an object as a specific character or a landmark are prepared in a game space (virtual space) is provided similar to the example of the fourth embodiment. In the game, it is also possible to use a NFT character. A hint for completing the mission is associated with the NFT character. Thus, a user acquires and uses an NFT character for one purpose of facilitating the completion of the mission. The NFT character is similar to that in the example of the fourth embodiment.

The sale of a plurality of NFT characters is similar to that in the example of the fourth embodiment. When a user makes a purchase, an NFT corresponding to a character is issued with the user who made the purchase as the owner. The NFT corresponding to the character can be traded (secondary distribution) on the NFT marketplace (blockchain network 30).

Determination of granting an in-game privilege is also similar to that in the example of the fourth embodiment. The in-game privilege is granted to the user of the game in accordance with transaction information (transaction status) of secondary distribution for an NFT corresponding to a character. Specifically, in a case where the granting condition related to the transaction information is satisfied, an in-game privilege is granted to the user of the game. Also, the granting condition is that the number of transactions (the number of concluded contracts) has reached a predetermined number (for example, 10 times) or more. Also, in the example of the present embodiment, whether the granting condition is satisfied is determined for each NFT corresponding to the character. The transaction history of the NFT corresponding to the character to be determined is referred to for determination of the granting condition.

Further, in the example of the present embodiment, similar to the example of the fourth embodiment, the granting condition is determined by using an NFT corresponding to a specific character as the target among NFTs corresponding to all characters. The NFT corresponding to the specific character is an NFT corresponding to a character having granting target information. That is, in a case where the total number of transfers (the number of transactions) of an NFT corresponding to one specific character has reached a predetermined number or more, the granting condition for the NFT is set to be satisfied. For example, it is determined whether the granting condition is satisfied by referring only to the transaction history of an NFT corresponding to a specific character C1, and it is determined whether the granting condition is satisfied by referring only to the transaction history of an NFT corresponding to a specific character C2. Also, for example, even in a case where there are a plurality of NFTs corresponding to the same specific character, it is determined whether the granting condition is satisfied for each NFT corresponding to the same specific character.

The in-game privilege is granted to the user who has satisfied the target person condition among the user who is the current owner and the user who was the past owner for the NFT corresponding to the content (the specific character) for which the granting condition has been satisfied. That is, the user is a user having a game user ID that has been registered in a server device 10E (storage device) among the current owner and the past owner. The in-game privilege is granted to the user who has satisfied the target person condition among these users.

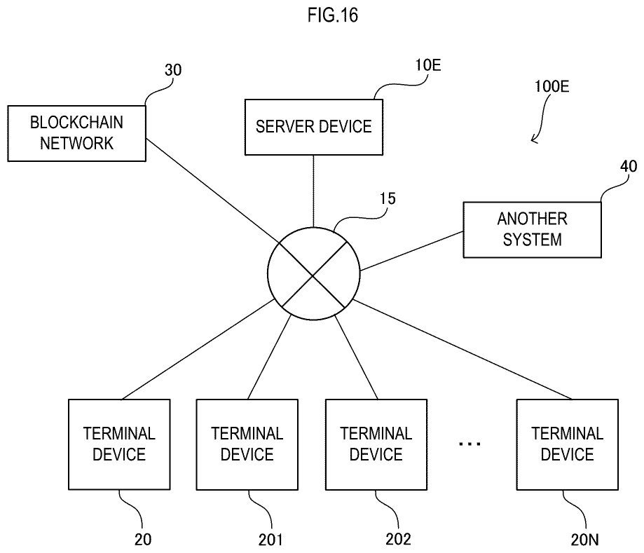

In the example of the present embodiment, the in-game privilege and the configuration of granting the in-game privilege are different from those in the example of the fourth embodiment. In the example of the present embodiment, a privilege associated with the above game in another system is granted as the in-game privilege. Another system is a system capable of providing a predetermined service related to the game to each user. In the example of the present embodiment, a predetermined role on the server related to the game on Discord is granted as the in-game privilege. on Discord, the server means a community on a network, which is established by voice channels and the like. Discord corresponds to another system 40 (see FIG. 16).

The server related to the game on Discord in the example of the present embodiment is, for example, a community related to the game created (managed) by the operator of the game. The role means a post (role) in the server, and an authority in the server can be set for each type of role.

The predetermined role described above is a role in which an authority to create a public thread and the like on the server related to the game on Discord is set.

Similar to the example of the fourth embodiment, the target person condition is a user who has logged in (played the game) within a predetermined period (for example, one month) after the granting condition is satisfied. That is, in a case where the user who is the current owner and the user of the game who was the past owner for the corresponding NFT has logged in within the predetermined period, the in-game privilege is granted. Specifically, a game system 100E (server device 10E) may transmit a setting request (granting request) for a predetermined role (in-game privilege) to the other system 40 when the user has logged in. More specifically, the game system 100E (server device 10E) may instruct the other system 40 to set a predetermined role for the user via a predetermined application programming interface (API).

FIG. 16 is a block diagram illustrating an example of a configuration of the game system 100E that is an example of the game system 100 in one embodiment of the present disclosure. As illustrated in FIG. 16, the system 100E includes the server device 10E and terminal devices 20 and 201 to 20N (N is any integer) respectively used by a plurality of users (players) who play a video game (game). The server device 10E and the plurality of terminal devices 20 and 201 to 20N are each connected to a communication network 15 such as the Internet.

The system 100E also includes a blockchain network 30. Furthermore, the system 100E (server device 10E) communicably cooperates with another system 40 via the communication network 15. The other system 40 is a system capable of providing a predetermined service related to the game to each user, as described above. In the example of the present embodiment, Discord corresponds to the other system 40. The other system 40 has an API. The other system 40 receives an instruction to grant the user a predetermined role in the server related to the game, from the server device 10E via the API.

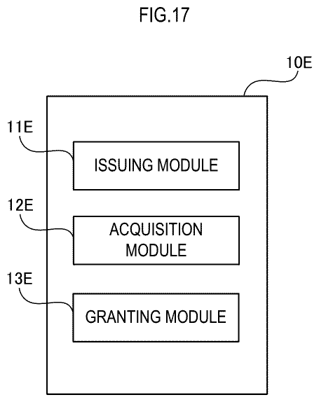

FIG. 17 is a block diagram illustrating a configuration of a server device 10E that is an example of the server device 10. In the example of the present embodiment, the server device 10E includes at least an issuing module 11E, an acquisition module 12E, and a granting module 13E.

The issuing module 11E is similar to the issuing module 11D in the fourth embodiment, and issues an NFT corresponding to a character with the user who is the acquirer (purchaser) of the content (character) as the owner. The issuing module 11E also has a sales function. The issuing module 11E displays, for example, a game image of a list of sellable characters on the terminal devices 20 and 201 to 20N of the users. The user may select a character desired to be purchased by operating the terminal device of the user. The information regarding the content to be sold may be stored in the storage device of the server device 10E.

When the issuing module 11E receives a purchase request for the selected character from the user (terminal device), the issuing module 11E executes a payment process (billing process) with the in-game currency possessed by the user. After completion of the billing process, the issuing module 11E transmits an issuing request for an NFT corresponding to the purchased content to the blockchain network 30. The issuing module 11E transmits (uploads) information specifying that this is a character of the game, information specifying the owner, granting target information, and the like to the blockchain network 30 together with an issuing request for an NFT. As a result, an NFT corresponding to the character is issued in the blockchain network 30. The issuing module 11E transmits the NFT corresponding to the character to a wallet (terminal device) of the purchaser (user).

The information specifying that this is the character of the game includes, for example, identification information (game ID) specifying the game and identification information (character ID) specifying the character in the example of the present embodiment. Each piece of identification information is stored in the storage device of the server device 10E.

The information specifying the owner is identification information (user ID) of the user who has purchased (acquired) the content. The user ID is a wallet address of the user (terminal device), for example. The user ID is also stored in the server device 10E as user data of the user.

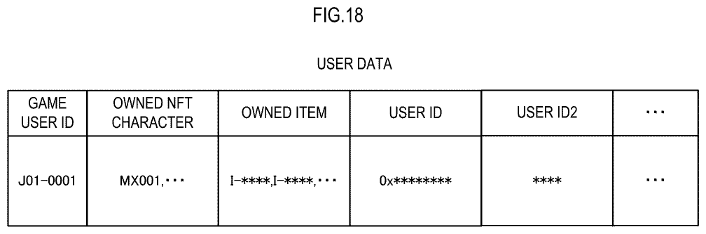

The user data is data regarding the game of the user, and is stored in the storage device of the server device 10 for each user. The user data is substantially similar to that in the example of the fourth embodiment, but is different from that in the example of the fourth embodiment in that a user ID2 is included as illustrated in FIG. 18. That is, the user data in the example of the present embodiment is configured by fields of a game user ID, an owned NFT character, an owned item, a user ID, and a user ID2, and the like. The user ID of the user in the other system 40 is set in the field of the user ID2.

Next, similar to the example of the fourth embodiment, the granting target information is identification information indicating the content (specific character) to which the in-game privilege is to be granted. The granting target information is stored in the storage device of the server device 10E in association with the character ID. In a case where the purchased character (character ID) is associated with the granting target information, the issuing module 11E transmits (uploads) an issuing request including the granting target information to the blockchain network 30. On the other hand, in a case where the purchased character (character ID) is not associated with the granting target information, the issuing request is transmitted to the blockchain network 30 without the granting target information.

The acquisition module 12E is similar to the acquisition module 12D in the fourth embodiment, and acquires transaction information of secondary distribution for each NFT corresponding to the character in the blockchain network 30. The transaction information is the transaction history described above. The acquisition module 12E requests the blockchain network 30 to transmit the transaction history of the content (NFT) having identification information specifying the game and the granting target information.

The granting module 13E grants an in-game privilege to a user of the game in a case where a granting condition related to the transaction information of the secondary distribution is satisfied. As described above, the granting condition is that the number of transactions (the number of concluded contracts) has reached a predetermined number (for example, 10 times) or more. The granting module 13E determines the granting condition for each transaction history of the NFT corresponding to the specific content (the specific character). That is, in a case where the total number of transfers of an NFT corresponding to one specific character has reached a predetermined number or more, the granting condition for the NFT is determined to be satisfied. The granting module 13E determines whether the granting condition is satisfied for each of the NFTs corresponding to all the specific contents.

The target person to whom the in-game privilege is granted is the user who is the current owner and the user who was the past owner for the NFT corresponding to the specific character for which the target person condition is satisfied, the current owner and the past owner satisfying the granting condition. The target person condition includes a user who has logged in (played the game) within a predetermined period (for example, one month) after the granting condition is satisfied. In a case where the corresponding user has logged in, the granting module 13E determines whether or not the current time when login has been performed is within a predetermined period (target person condition). The granting module 13E grants an in-game privilege to the corresponding user in a case where the current time when login has been performed is within the predetermined period. Specifically, the granting module 13E acquires the user ID in the other system 40 in the user data (user ID2) of the corresponding user. Further, the granting module 13E transmits a granting request for a predetermined role (in-game privilege) to the other system 40 together with the user ID in the other system 40 and the identification information of the predetermined role. More specifically, the granting module 13E instructs the other system 40 to set the predetermined role to the user via the API, by using the user ID in the other system 40, the identification information of the predetermined role, and the like as input information.

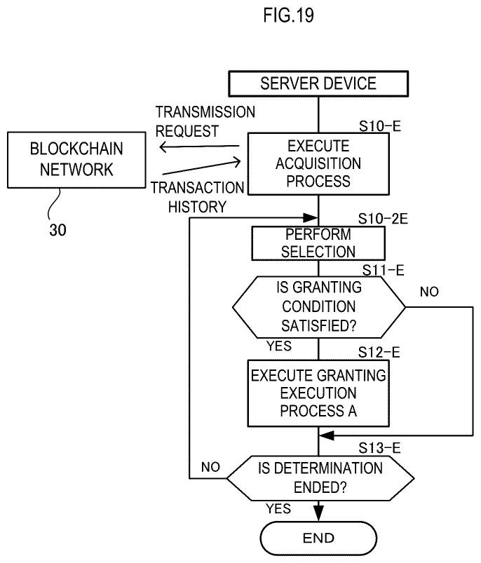

FIG. 19 is a flowchart illustrating an example of a granting process executed by the system 100E. The granting process in the example of the present embodiment is a process for granting an in-game privilege. FIG. 19 mainly illustrates a process for acquiring transaction information and a process for granting an in-game privilege to the user, and other processes may be partially omitted.

The granting process in the example of the present embodiment is repeatedly executed, for example, every time a predetermined period of time has elapsed (for example, 24 hours have elapsed).

The server device 10E executes an acquisition process of a transaction history (Step S10-E). In the acquisition process, the blockchain network 30 is requested to transmit the transaction history of the NFT corresponding to the specific content. Specifically, the server device 10E transmits a transmission request of the transaction history to the blockchain network 30 together with identification information (game ID) specifying the game and the granting target information. As a result, only the transaction history of the NFT corresponding to the specific content is transmitted from the blockchain network 30 to the server device 10E.

Then, the server device 10E selects a transaction history of one NFT for which the granting condition has not been determined (Step S10-2E). The server device 10E determines whether or not the granting condition is satisfied with reference to the selected transaction history of the one NFT (Step S11-2E). In a case where the granting condition is not satisfied (Step S11-E: NO), the server device 10E proceeds to the process of Step S13-E.

On the other hand, in a case where the granting condition is satisfied (Step S11-E: YES), the server device 10E executes a granting execution process A (Step S12-E). In the granting execution process A, a process for granting an in-game privilege to the user is executed. The server device 10E refers to the transaction history selected in the process of Step 10-2E, and specifies the user (user ID) who is the current owner of the NFT corresponding to the content in this transaction history and the user (user ID) who was the past owner of the NFT corresponding to the content in this transaction. Then, the server device 10E performs setting such that the in-game privilege is granted to a user who has logged in before a predetermined period of time has elapsed among the specified users (user IDs). Specifically, the server device 10E sets, in the storage device, the start time and the end time of the predetermined period and the game user ID of the specified user (user ID) who is the user to whom the in-game privilege is scheduled to be granted.

Then, the server device 10E determines whether or not determination of the granting condition has been ended for NFTs corresponding to all specific contents (Step S13-E). In a case where it is determined that the determination has not ended (Step S13-E: NO), the server device 10E returns to the process of Step S10-2E and newly selects the transaction history of one NFT for which the granting condition has not been determined. On the other hand, in a case where it is determined that the determination has ended (Step S13-E: YES), the server device 10E ends the granting process.

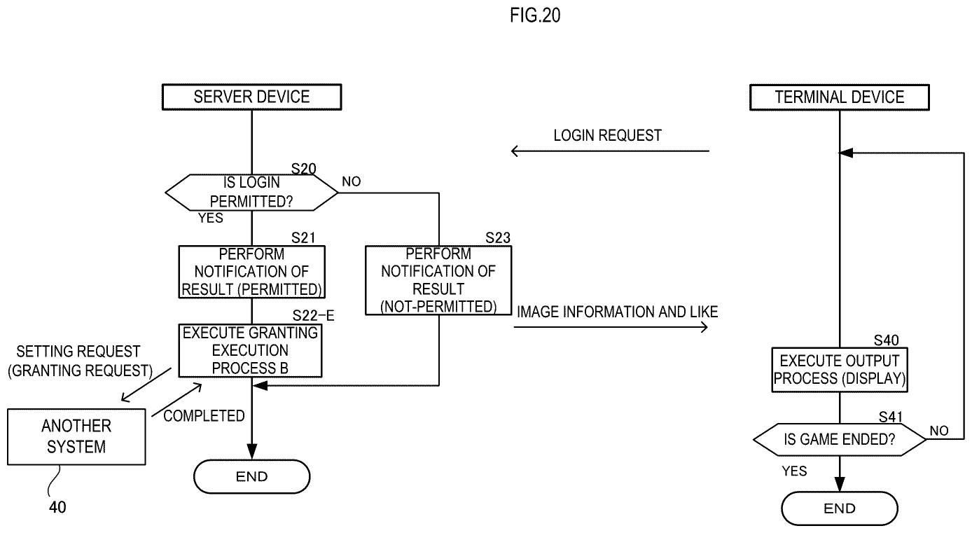

FIG. 20 is a flowchart illustrating an example of a login process executed by the system 100E. The login process in the example of the present embodiment is a process for authenticating the user. FIG. 20 mainly illustrates a process for granting the in-game privilege to the user who has logged in, and other processes may be partially omitted. A case where the server device 10E and the terminal device 20 of a user P execute the login process will be described below as an example.

Execution of the login process in the example of the present embodiment is started, for example, in a case where the terminal device 20 issues a login request. The terminal device 20 transmits a login request to the server device 10E together with authentication information such as the game user ID and the authentication password of the user P, for example.

The server device 10E determines whether or not to permit the login (Step S20). For example, the server device 10E may perform authentication by comparing the received authentication information with the user ID or the like included in the user data stored in the storage module. In a case where the login is not permitted (Step S20: NO), the server device 10E may, for example, transmit, to the terminal device 20, image information for a notification of the result that the login is not permitted (Step S23). Thereafter, the server device 10E ends the login process.

On the other hand, in a case where the login is permitted (Step S20: YES), the server device 10E may, for example, transmit, to the terminal device 20, image information for a notification of the result that the login is permitted (Step S21). Then, the server device 10E executes a granting execution process B (Step S22-E). In the granting execution process B, the in-game privilege is granted to the user to whom the in-game privilege is scheduled to be granted, in a case where the current time is within the predetermined period. For example, in a case where the current time is within the predetermined period and the user P (game user ID) corresponds to a user (game user ID) to whom an in-game privilege is scheduled to be granted, the in-game privilege is granted to the user P. Specifically, the server device 10E acquires the user ID of the user P in the other system 40 with reference to the user data (user ID2). In addition, the server device 10E transmits a setting request for a predetermined role (in-game privilege) to the other system 40 together with the user ID in the other system 40 and the identification information of the predetermined role. More specifically, the server device 10E instructs to set the role to the user through the API (the other system 40), by using the user ID in the other system 40, the identification information of the predetermined role, and the like as input information. The API can be specified by, for example, a URL. Thereafter, the server device 10E receives information of the completion of setting (granting the in-game privilege) from the other system 40. In the granting execution process B, in a case where the in-game privilege is granted, for example, image information for a notification indicating that the in-game privilege has been granted is transmitted from the server device 10E to the terminal device 20. Thereafter, the server device 10E ends the login process. In a case where the current time is not within the predetermined period or in a case where the user who has logged in is not a granting candidate, the server device 10E ends the granting execution process B without granting the in-game privilege.

The in-game privilege is granted only once. The server device 10E may store, for example, the user (game user ID) to whom the in-game privilege is granted, in the storage device. Then, in a case where the game user ID of the logged-in user is already included in the game user IDs to which the in-game privilege has been granted, the server device 10E may end the granting execution process B without granting the in-game privilege.

On the other hand, the terminal device 20 displays the game image based on the image information and the like received from the server device 10E on the display until the execution of the game is ended (Step S41: YES) (Step S40). In a case where the in-game privilege has been granted, the terminal device 20 displays a game image for a notification indicating that the in-game privilege has been granted.

Although the login process illustrated in FIG. 20 has been described with respect to the terminal device 20, the similar process may be executed for other users (terminal devices).

As described above, as one aspect of the fifth embodiment, the server device 10E is configured to include the issuing module 11E, the acquisition module 12E, and the granting module 13E. Thus, the in-game privilege is granted in accordance with the transaction status of the NFT corresponding to the content in the game. Therefore, the NFT transaction and the game play are configured to be more associated with each other, and thus it is possible to improve the interest of the game.

In addition, since the transaction information (transaction status) to be acquired is limited to the NFT corresponding to the specific content, the amount of data to be acquired from the blockchain network is reduced. Thus, it is possible to suppress an increase in processing load on the blockchain network.

Furthermore, since the in-game privilege is granted to the user involved in the transaction of the NFT corresponding to the content used in the game, it is possible to improve the willingness of the user to perform both an NFT transaction and the game play.

In addition, the privilege (predetermined role) associated with the game in the other system 40 is granted as the in-game privilege, and this contributes to increasing the motivation of the user who plays the game.

In the example in the embodiment described above, the configuration in which the in-game privilege is granted to the user who is the current owner and the user who was the past owner has been described, but the present embodiment is not particularly limited to this. For example, the in-game privilege may be granted only to the user who is the current owner, or only to the past owner. Furthermore, another condition may be added. For example, an in-game privilege may be granted only to the original owner of the NFT corresponding to the content among the past owners. Further, for example, the in-game privilege may be granted only to a user among the past owners who has logged in to the game within a predetermined period after the granting condition is satisfied.

Games of various genres can be adopted as the video game in the example in the above-described embodiment as long as the contents such as the characters are used in the game.

Regarding the content (characters) in the example in the above-described embodiment, a plurality of the same contents may be provided, or contents of different types may be provided.

The issuing module in the example in the above-described embodiment may be configured to issue an NFT request to the blockchain network to issue an NFT, or may be configured to issue an NFT itself. Further, the NFT issuance by the issuing module also includes a configuration in which an issued NFT corresponding to the content, the owner of the NFT being an operator of the game, is transferred to the user.

In the example in the embodiment described above, a configuration in which an NFT is issued when a content in the game is purchased by the user has been described, but the subject of NFT issuance is not particularly limited to this. The content may be acquired by the user, and may be, for example, acquired (given) to the user as a result of playing the game.

In the example in the embodiment described above, the number of transactions in the transaction history has been described as the transaction information, but the transaction information is not particularly limited to this as long as the transaction information is information associated with a transaction of the secondary distribution. For example, the transaction information may be a transaction price. The transaction price is included in the transaction history of the NFT. In this case, for example, a granting condition in which the total transaction price has reached a predetermined amount or more may be set. Further, for example, a granting condition in which there is a transaction concluded at a predetermined transaction price or more may be set.

In the example in the embodiment described above, only one granting condition is provided, but a plurality of conditions may be provided. For example, conditions A, B, and C may be provided as the granting conditions. In this case, in a case where any one of the conditions A, B, and C is satisfied, the in-game privilege may be granted on the assumption that the granting condition has been satisfied. Alternatively, in a case where all the conditions A, B, and C are satisfied, the in-game privilege may be granted on the assumption that the granting condition has been satisfied. Also, the granting condition may be changed periodically.

In the example of the embodiment described above, the predetermined role is granted as the privilege (in-game privilege) associated with the game in the other system, but the present embodiment is not particularly limited to this. For example, participation qualifications to communities associated with the game in the other system may be granted.

In the example of the embodiment described above, Discord is applied as the other system, but the present embodiment is not particularly limited to this. As the other system, any system can be applied so long as the system can provide each user with a predetermined service associated with the game. For example, there is a communication platform such as “Element”.

In the example in the embodiment described above, the transaction information of the NFT corresponding to the content is used for the entire period from the past to the present, but the present embodiment is not particularly limited to this. The granting condition may be determined by using transaction information for a specific period (for example, a period from the present to one year ago).

In the example of the above-described embodiment, a target person condition is provided, but the in-game privilege may be granted to all users of the game without setting the target person condition. Also, the target person condition may be set to include a plurality of conditions, similar to the granting condition. For example, a condition of owning an NFT corresponding to a specific content may be included in the target person condition. The specific content may be set to, for example, an NFT corresponding to the content (character) including the granting target information in the example of the present embodiment.

The start time and the end time of the predetermined period in the example of the above-described embodiment may be any time after the granting condition is satisfied.

In the example of the embodiment described above, the transaction history of the NFT corresponding to the specific content is acquired, but the present embodiment is not particularly limited to this. The server device may acquire transaction histories of NFTs corresponding to all contents, and determine the granting conditions with reference to only the necessary transaction history.

In the example in the above-described embodiment, the operating entity of the server device and the operating entity of the blockchain network may be different or the same.

### Appendix

The above description of the embodiments is disclosed in order for those of ordinary knowledge in the field of the invention to embody at least the following invention.

[1] A video game processing program for causing a computer to realize a function of controlling progress of a video game including one or more contents used in a game,
the video game processing program causing the computer to realize:
an issuing function of issuing a non-fungible token (referred to as an NFT below) corresponding to the content in a blockchain network, with a user who is an acquirer of the content as an owner,
an acquisition function of acquiring transaction information of secondary distribution for each NFT corresponding to the content in the blockchain network, and
a granting function of granting an in-game privilege to a user of the video game in a case where a granting condition related to the transaction information is satisfied.

[2] The video game processing program described in [1], in which
the transaction information includes identification information of a transferor and a transferee of the NFT corresponding to the content, and
in the granting function, the in-game privilege is granted to a user who is the current owner and/or a user who was the past owner for the NFT corresponding to the content for which the granting condition related to the transaction information is satisfied.

[3] The video game processing program described in [1], in which
the granting condition includes a condition that a number of transactions of the NFT corresponding to the content has reached a predetermined number, and
in the granting function, the in-game privilege is granted to a user who has logged into the game during a predetermined period, in a case where the granting condition is satisfied.

[4] The video game processing program described in [1], in which
the computer is caused to communicably cooperate with another system capable of providing each user with a predetermined service related to the video game via a communication network, and
the in-game privilege includes a privilege associated with the video game on the other system.

[5] The video game processing program described in [4], in which
in the granting function, a granting request of the privilege associated with the video game is transmitted to the other system, including identification information of the user of the video game in the other system, in a case where the granting condition is satisfied.

[6] The video game processing program described in any one of [1] to [3], in which
a plurality of the contents are provided,
in the issuing function, an NFT is issued by associating granting target information with a content to which the in-game privilege is to be granted among the plurality of contents, and
in the acquisition function, the transaction information of the NFT associated with the granting target information among NFTs corresponding to the contents is acquired.

[7] The video game processing program described in any one of [1] to [3], in which
in the issuing function, an NFT corresponding to the in-game privilege is issued with a user to whom the in-game privilege is granted as the owner.

[8] The video game processing program described in any one of [1] to [7], in which
in the granting function, the in-game privilege is granted to a user who satisfies a target person condition among users of the video game.

[9] The video game processing program described in any one of [1] to [8], in which
the transaction information includes a transaction date and time of the NFT corresponding to the content, and
in the granting function, the granting condition is determined based on the transaction information within a predetermined period.

[10] A server device in which the video game processing program described in any one of [1] to [9] is installed.

[11] A video game processing program for causing a server device connected to a game terminal device that executes a video game including one or more contents used in the game via a communication network, to control progress of the video game,
the video game processing program causing the server device to realize:
an issuing function of issuing a non-fungible token (referred to as an NFT below) corresponding to the content in a blockchain network, with a user who is an acquirer of the content as an owner,
an acquisition function of acquiring transaction information of secondary distribution for each NFT corresponding to the content in the blockchain network, and
a granting function of granting an in-game privilege to a user of the video game in a case where a granting condition related to the transaction information is satisfied.

[12] The video game processing program described in [11], in which
the transaction information includes identification information of a transferor and a transferee of the NFT corresponding to the content, and
in the granting function, the in-game privilege is granted to a user who is the current owner and/or a user who was the past owner for the NFT corresponding to the content for which the granting condition related to the transaction information is satisfied.
[13] The video game processing program described in [11], in which
the granting condition includes a condition that a number of transactions of the NFT corresponding to the content has reached a predetermined number, and
in the granting function, the in-game privilege is granted to a user who has logged into the game during a predetermined period, in a case where the granting condition is satisfied.

[14] The video game processing program described in [11], in which
the server device is caused to communicably cooperate with another system capable of providing each user with a predetermined service related to the video game via a communication network, and
the in-game privilege includes a privilege associated with the video game on the other system.

[15] The video game processing program described in [14], in which
in the granting function, a granting request of the privilege associated to the video game is transmitted to the other system, including identification information of the user of the video game in the other system, in a case where the granting condition is satisfied.

[16] The video game processing program described in any one of [11] to [13], in which
a plurality of the contents are provided,
in the issuing function, an NFT is issued by associating granting target information with a content to which the in-game privilege is to be granted among the plurality of contents, and
in the acquisition function, the transaction information of the NFT associated with the granting target information among NFTs corresponding to the contents is acquired.

[17] The video game processing program described in any one of [11] to [13], in which
in the issuing function, an NFT corresponding to the in-game privilege is issued with a user to whom the in-game privilege is granted as the owner.

[18] The video game processing program described in any one of [11] to [17], in which
in the granting function, the in-game privilege is granted to a user who satisfies a target person condition among users of the video game.

[19] The video game processing program described in any one of [11] to [18], in which
the transaction information includes a transaction date and time of the NFT corresponding to the content, and
in the granting function, the granting condition is determined based on the transaction information within a predetermined period.

[20] A game system including:
a game terminal device that executes a video game including one or more contents used in a game; and
a server device that is connected to the game terminal device via a communication network and controls progress of the video game, in which
the game system includes
an issuer for issuing a non-fungible token (referred to as an NFT below) corresponding to the content in a blockchain network, with a user who an acquirer of the content as an owner,
an acquirer for acquiring transaction information of secondary distribution for each NFT corresponding to the content in the blockchain network, and
a granter for granting an in-game privilege to a user of the video game in a case where a granting condition related to the transaction information is satisfied.

[21] The game system described in [20], in which
the transaction information includes identification information of a transferor and a transferee of the NFT corresponding to the content, and
the granter grants the in-game privilege to a user who is the current owner and/or a user who was the past owner for the NFT corresponding to the content for which the granting condition related to the transaction information is satisfied.

[22] The game system described in [20], in which
the granting condition includes a condition that a number of transactions of the NFT corresponding to the content has reached a predetermined number, and
the granter grants the in-game privilege to a user who has logged into the game during a predetermined period, in a case where the granting condition is satisfied.

[23] The game system described in [20], in which
a predetermined service associated with the video game communicably cooperates with another system capable of providing the predetermined service to each user via a communication network, and
the in-game privilege includes a privilege associated with the video game on the other system.

[24] The game system described in [23], in which
the granter transmits a granting request of the privilege associated to the video game to the other system, including identification information of the user of the video game in the other system, in a case where the granting condition is satisfied.

[25] The game system described in any one of [20] to [22], in which
a plurality of the contents are provided,
the issuer issues an NFT by associating granting target information with the content to which the in-game privilege is to be granted among the plurality of contents, and
the acquirer acquires the transaction information of an NFT associated with the granting target information among NFTs corresponding to the contents.

[26] The game system described in any one of [20] to [22], in which
the issuer issues an NFT corresponding to the in-game privilege with a user to whom the in-game privilege is granted as the owner.

[27] The game system described in any one of [20] to [26], in which
the granter grants the in-game privilege to a user who satisfies a target person condition among the users of the video game.

[28] The game system described in any one of [20] to [27], in which
the transaction information includes a transaction date and time of the NFT corresponding to the content, and
the granter determines the granting condition based on the transaction information within a predetermined period.

[29] A video game processing method that is a game progress control method for causing a computer to control progress of a video game including one or more contents used in a game, the video game processing method including:
an issuing process of issuing a non-fungible token (referred to as an NFT below) corresponding to the content in a blockchain network, with a user who an acquirer of the content as an owner;
an acquisition process of acquiring transaction information of secondary distribution for each NFT corresponding to the content in the blockchain network; and
a granting process of granting an in-game privilege to a user of the video game in a case where a granting condition related to the transaction information is satisfied.

According to one embodiment of the present disclosure, in a video game, an NFT transaction and the game play are more associated with each other, and thus the embodiment is useful for improving the interest of the game.

What is claimed is:

1. A game system comprising:
a game terminal device configured to execute a video game including one or more contents used in a game;
a server device configured to connect to the game terminal device via a communication network and configured to control progress of the video game; and
one or more controllers configured to:
issue a non-fungible token (NFT) corresponding to the content in a blockchain network, with a user who is an acquirer of the content as an owner,
acquire transaction information of secondary distribution for each NFT corresponding to the content in the blockchain network, and
grant an in-game privilege to a user of the video game, if a granting condition related to the transaction information is satisfied.

2. The game system according to claim 1, wherein the transaction information comprises identification information of a transferor and a transferee of the NFT corresponding to the content, and
wherein the one or more controllers are configured to grant the in-game privilege to at least one of a user who is the owner of the NFT or a user who was a past owner of the NFT corresponding to the content for which the granting condition related to the transaction information is satisfied.

3. The game system according to claim 1,
wherein the granting condition comprises a condition that a number of transactions of the NFT corresponding to the content has reached a predetermined number, and
wherein the one or more controllers are configured to grant the in-game privilege to a user who has logged into the game during a predetermined period, if the granting condition is satisfied.

4. The game system according to claim 1, wherein the game system is configured to communicably cooperate with another system configured to provide a predetermined service associated with the video game to each user via the communication network, and
wherein the in-game privilege comprises a privilege associated with the video game on the other system.

5. The game system according to claim 4, wherein the one or more controller is configured to transmit a granting request of the privilege associated to the video game to the other system, the granting request comprising identification information of the user of the video game in the other system, if the granting condition is satisfied.

6. The game system according to claim 1, wherein the video game comprises a plurality of contents,
wherein the one or more controllers are configured to:
issue an NFT by associating granting target information with a content to which the in-game privilege is to be granted among the plurality of contents; and
acquire the transaction information of the NFT associated with the granting target information among NFTs corresponding to the contents.

7. The game system according to claim 1, wherein the one or more controllers are configured to issue an NFT corresponding to the in-game privilege with a user to whom the in-game privilege is granted as the owner.

8. The game system according to claim 1, wherein the one or more controllers are configured to grant the in-game privilege to a user who satisfies a target person condition among the users of the video game.

9. The game system according to claim 1, wherein the transaction information comprises a transaction date and time of the NFT corresponding to the content, and
wherein the one or more controllers are configured to determine the granting condition based on transaction information within a predetermined period.

10. A non-transitory computer-readable medium including a video game processing program including instructions, when executed by one or more controllers, causing a computer that is configured to control progress of a video game including one or more contents, to perform operations comprising:
issuing an NFT corresponding to the content in a blockchain network, with a user who is an acquirer of the content as an owner;
acquiring transaction information of secondary distribution for each NFT corresponding to the content in the blockchain network; and
granting an in-game privilege to a user of the video game if a granting condition related to the transaction information is satisfied.

11. A non-transitory computer-readable medium including a video game processing program including instructions, when executed by one or more controllers, causing a server device connected to a game terminal device executing a video game via a communication network and configured to control progress of the video game to perform operations comprising:
issuing an NFT corresponding to the content in a blockchain network, with a user who is an acquirer of the content as an owner;
acquiring transaction information of secondary distribution for each NFT corresponding to the content in the blockchain network; and
granting an in-game privilege to a user of the video game if a granting condition related to the transaction information is satisfied.
